(19) United States
(12) Patent Application Publication
(10) Pub. No.: US 2025/0175355 A1
(43) Pub. Date: May 29, 2025

(54) Private Permissioned Hierarchical Blockchains over Fog/Edge and Multi-Cloud Computing Networks

(71) Applicant: The Government of the United States, as represented by the Secretary of the Army, Washington, DC (US)

(72) Inventor: Radhika Roy, Howell, NJ (US)

(21) Appl. No.: 18/518,659

(22) Filed: Nov. 24, 2023

(51) Int. Cl. H04L 9/00

(52) U.S. Cl. CPC H04L 9/50

(57) ABSTRACT

Various embodiments that pertain to private permissioned hierarchical blockchains are described over fog/edge and multi-Cloud computing networks. In one example, a blockchain component can manage a private permissioned blockchain. An engagement component can engage a user with a network by way of the private permissioned blockchain. The network can be of different configurations, such as comprising at least one node (e.g., a first node and a second node) as well as being an access network, a backbone network, or a hybrid network. A communication component can enable a communication with the user and the network, such as the first node, by way of the private permissioned blockchain.

### GOVERNMENT INTEREST

The innovation described herein may be manufactured, used, imported, sold, and licensed by or for the Government of the United States of America without the payment of any royalty thereon or therefor.

### BACKGROUND

Security can be a critical feature in a combat environment. For example, when communicating information it can be important that the desired party receive the information without the information falling into enemy hands. Further, avenues of communication along with information tools should be secure to make sure information does not fall into enemy hands.

### SUMMARY

In one embodiment, a system can comprise a blockchain component configured to manage a private permissioned blockchain. The system can also comprise an engagement component configured to engage with a user with a network by way of the private permissioned blockchain, the network comprising a first node and a second node. The system can additionally comprise a communication component configured to enable a communication with the user and the first node by way of the private permissioned blockchain.

In another embodiment, a system can comprise a blockchain component configured to manage an access network private permissioned blockchain. The system can also comprise an engagement component configured to engage a user with an access network by way of the access network private permissioned blockchain, the access network comprising at least one node. The system can additionally comprise a communication component configured to enable communication with the user and the access network by way of the access network private permissioned blockchain.

In yet another embodiment, a system can comprise a blockchain component configured to manage a backbone-based private permissioned blockchain. The system can also comprise an engagement component configured to engage a user with a backbone network by way of the backbone-based private permissioned blockchain, the backbone network comprising at least one node. The system can additionally comprise a communication component configured to enable communication with a user and the backbone network by way of the backbone-based private permissioned blockchain

### BRIEF DESCRIPTION OF THE DRAWINGS

Incorporated herein are drawings that constitute a part of the specification and illustrate embodiments of the detailed description. The detailed description will now be described further with reference to the accompanying drawings as follows:

FIG. 1 illustrates one embodiment of a communications network;

FIG. 2 illustrates one embodiment of a schematic view of a large-scale hierarchical communications network;

FIG. 3 illustrates one embodiment of a high-level view of a communications network;

FIG. 4 illustrates one embodiment of a high-level logical view of cloud and fog/edge computing services over a communications network;

FIG. 5 illustrates one embodiment of multiple cloud computing systems over a backbone network;

FIG. 6 illustrates one embodiment of a logical view of a cloud, hybrid computing, and fog/edge computing blockchain network with a single cloud;

FIG. 7 illustrates one embodiment of a logical view of a cloud, hybrid computing, and fog/edge computing blockchain network with multiple clouds over a blockchain network;

FIG. 8 illustrates one embodiment of a high-level view of a blockchain overlay network over a communications network;

FIG. 9 illustrates one embodiment of a blockchain working flow;

FIG. 10 illustrates one embodiment of blockchain phases of a smart contract: creation, deployment, execution, and completion;

FIG. 11 illustrates one embodiment of a high-level view of blockchain-based cloud and fog/edge computing layers;

FIG. 12 illustrates one embodiment of a workflow of a smart contract;

FIG. 13 illustrates one embodiment of a flow of dynamic negotiations in blockchain nodes;

FIG. 14 illustrates one embodiment of a flow for a monitor & control smart contact. As an example, this can be for Internet of Things/drone/sensors for transparent information sharing;

FIG. 15A illustrates a high-level logic flow of smart contracts and transparent information sharing;

FIG. 15B illustrates a low-level logic flow for members of the fog/edge computing blockchian network of smart contracts and transparent information sharing;

FIG. 15C illustrates a low-level logic flow for members of the hybrid computing blockchian network of smart contracts and transparent information sharing;

FIG. 15D illustrates a low-level logic flow for members of the cloud computing blockchian network of smart contracts and transparent information sharing;

FIG. 16 illustrates one embodiment of a system comprising a blockchain component, an engagement component, and a communication component;

FIG. 17 illustrates one embodiment of a system comprising the blockchain component, the engagement component, the communication component, an identification component, and a fulfillment component;

FIG. 18 illustrates one embodiment of a system comprising the blockchain component, the engagement component, the communication component, the identification component, the fulfillment component, an evaluation component, a determination component, and a selection component;

FIG. 19 illustrates one embodiment of a system comprising the blockchain component, the engagement component, the communication component, the identification component, the fulfillment component, an analysis component, a check component, and a reward component;

FIG. 20 illustrates one embodiment of a system comprising the blockchain component, the engagement component, the communication component, a call component, a bid component, an appraisal component, a trustworthiness component, a decision component, and a control component;

FIG. 21 illustrates one embodiment of a system comprising the processor and the computer-readable medium;

FIG. 22 illustrates one embodiment of a method comprising five actions;

FIG. 23 illustrates one embodiment of a method comprising four actions;

FIG. 24 illustrates one embodiment of a method comprising four actions; and

FIG. 25 illustrates one embodiment of a method comprising four actions.

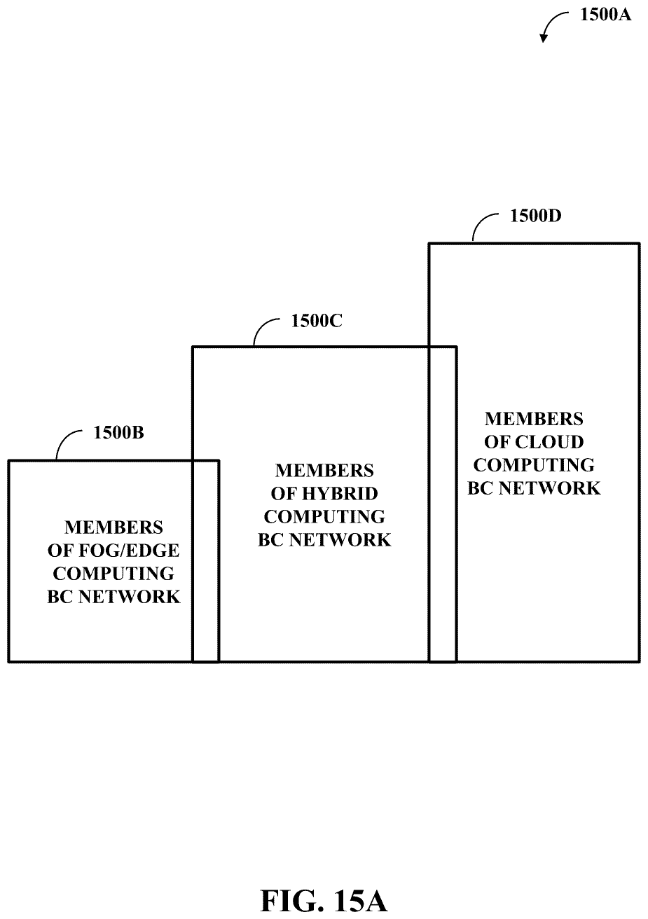

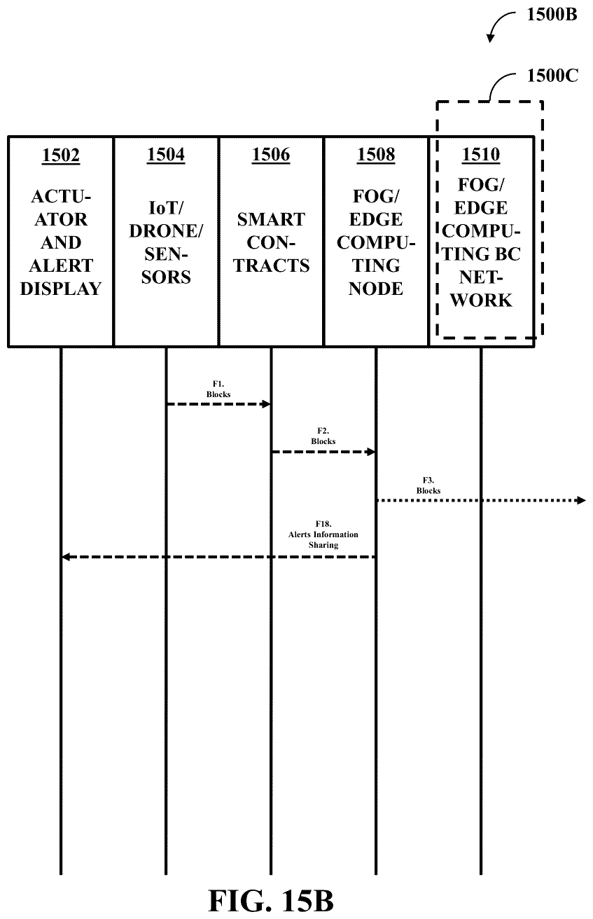

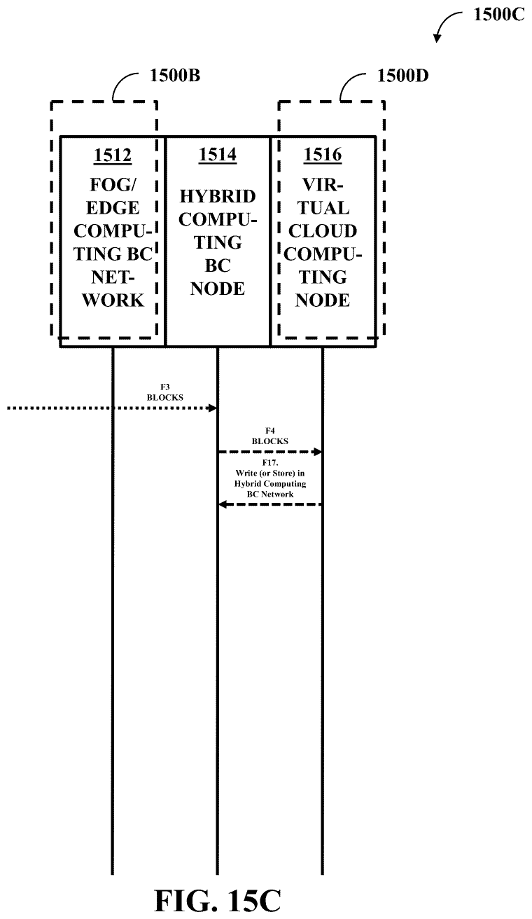

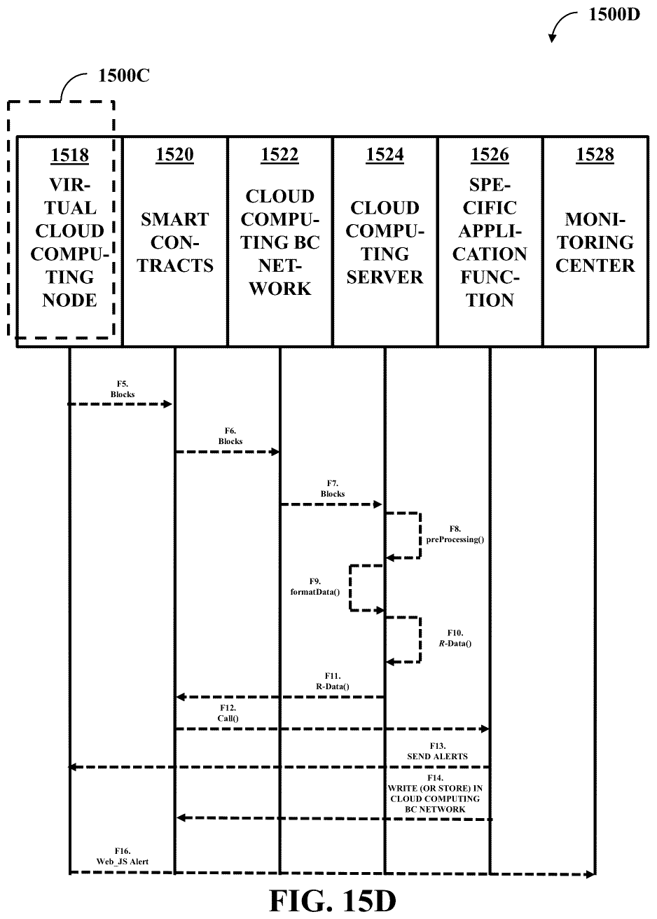

Figures can be referred to collectively. For example, a reference to “the cooling apparatus of FIG. 15” can refer to FIG. 15A as well as FIG. 15B.

### DETAILED DESCRIPTION

A private permissioned blockchain and smart contracts-based immutable cybersecurity mechanisms can be employed for Cloud and Fog/Edge Computing. Concepts for these can be real-time (e.g. audio, video) including collaborative command & control and non-real-time (e.g. data) including Software-as-a-Service (SaaS), Platform-as-a-Service (PaaS), and Infrastructure-as-a-Service (IaaS) applications. Disclosed security mechanisms can be used for various applications, including centralized, distributed, or hybrid communications architectures equally applicable for communications (e.g., commercial) networks. A private permissioned blockchain network can work in some ways the same as a permission-less public blockchain network, but also with important, significant, and fundamental differences.

There can be a single or multiple clouds and/or a single or multiple fog/edge computing centers or nodes. Unlike a public blockchain network that has a very limited throughput-capacity to support primarily the non-real-time financial transactions with long delays, the private permissioned blockchain network can have very high-throughput capacity with extremely low delays supporting both real-time and non-real-time applications meeting both performance and functional requirements.

Unlike a public blockchain, a private permissioned blockchain network can use a consensus algorithm(s) suitable to meet the stringent performance requirements for the real-time audio and video conversational communications using logically centralized cloud computing and distributed fog/edge computing architecture. Similar to public blockchain networks, smart contracts can be used that are finalized between the service provider and end-users/customers at the time of service provisioning and stored over the blockchain network. Later these service contracts can be triggered by end-users/customers and services are automatically executed using a-priori developed algorithms over the blockchain network.

Unlike public blockchain networks, the private permissioned blockchain network can be a number of different blockchain networks (e.g. fog/edge computing blockchain network, hybrid computing blockchain network, and/or cloud computing blockchain network) based on the hierarchy of topology design (e.g. premises networks, access networks, and global backbone network) of large-scale communications network spanning over the entire world for providing scalability, thereby, offering economies-of-scale.

General working principles of private permissioned fog/edge computing blockchain network, hybrid computing blockchain network, and cloud computing blockchain network can be similar to those of the public blockchain network, but there are also some differences.

A Fog/Edge Computing blockchain (BC) network can comprise the members of the fog/edge computing nodes where each fog/edge computing node can act as a single point of contact for a given end-user/customer that contacts the node for services. A communications network can have one or more fog/edge computing BC networks for scalability. A fog/edge computing can also be the member of both Fog/Edge and Cloud Computing BC networks keeping the BC networks “logically” separate.

A Hybrid Computing Blockchain Network can comprise members of the fog/edge computing nodes as well as a “virtual” cloud computing node. A “virtual” cloud computing node can be a single point of contact for a given cloud where a group of computing nodes reside in different geographical locations. A communications network can have one or more hybrid computing BC networks for scalability.

A Cloud Computing Blockchain Network can comprise members of cloud computing nodes of a given cloud computing center as well as at least one “virtual” cloud computing node that acts a single point of contact for accessing a given cloud. A “Virtual” Cloud Computing Node can be be a member of both Cloud and Hybrid Computing BC Network keeping the both BC networks “logically” separate. A communications network can have one or more clouds for scalability, such as an individual cloud having its own independent cloud computing BC network for scalability. Implementation can be with a single cloud or a subset of multiple clouds.

Services that are offered by different blockchain networks over the communications network can be transparent to end-users/customers. End-Users/Customers can have restricted access, such as only being able to access through the fog/edge computing blockchain network. Edge/Fog computing node through which an end-user/customer gains access into the network can act as the sole single-point of contact for various computing services.

Computing services of an end-user/customer can be provided by anywhere over the communications network transparently either in a given computing center (e.g. fog/edge or cloud), distributed over the multiple computing centers simultaneously (e.g. multiple fog/edge or multiple cloud) simultaneously, or a hybrid combinations of fog/edge and cloud computing centers simultaneously. Smart Contracts can be employed for facilitating “dynamic” negotiations in real-time which a preferred BC computing node (e.g., optimal) is chosen to handle to given computing offering lowest coast and superior performance. Smart Contracts can be used for trusted dynamic negotiations over the private permissioned BC network, such as over the fog/edge BC network.

A blockchain network can act as the signaling networks for handling the headers of the transactions that are kept as a chain of consecutive blocks stored over multiple locations where miners reside, but actual payloads of transactions can be sent from the source to the destinations directly bypassing blockchain networks using secured cryptographic keys and encoding schemes (e.g. Boolean, cuckoo or other filters, and fingerprints) simultaneously offering immutable cybersecurity for using blockchain networks and scalability for not transferring the actual payloads of transactions over blockchain networks. However, payloads of transactions can be sent directly over the BC network as long as it is cost-effective. For example, a payload-size similar to that of the public BC network can transferred directly over the private permissioned BC network. Cost-Performance tradeoffs analysis for how much of sending traffic payloads should be transferred over either in the BC network, in the non-BC, or a combination of both BC and Non-BC network can provide what should be appropriate.

BC network can also be used for storage of the payload traffics purpose. Building databases for storing data in the BC network and making them secured can be achieved with different efficient schemes such peer-to-peer distributed hash table (DHT).

Aspects disclosed herein relate to cloud and fog/edge computing services communications network architecture, BC network architectures over the cloud and fog/edge computing communications networks, smart contracts-based trusted dynamic negotiations for providing scalable computing services, and distributed verifications of rewards/incentives and trust reputation.

The following includes definitions of selected terms employed herein. The definitions include various examples. The examples are not intended to be limiting.

“One embodiment”, “an embodiment”, “one example”, “an example”, and so on, indicate that the embodiment(s) or example(s) can include a particular feature, structure, characteristic, property, or element, but that not every embodiment or example necessarily includes that particular feature, structure, characteristic, property, or element. Furthermore, repeated use of the phrase “in one embodiment” may or may not refer to the same embodiment.

“Computer-readable medium”, as used herein, refers to a medium that stores signals, instructions and/or data. Examples of a computer-readable medium include, but are not limited to, non-volatile media and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, other optical medium, a Random Access Memory (RAM), a Read-Only Memory (ROM), a memory chip or card, a memory stick, and other media from which a computer, a processor or other electronic device can read. In one embodiment, the computer-readable medium is a non-transitory computer-readable medium.

“Component”, as used herein, includes but is not limited to hardware, firmware, software stored on a computer-readable medium or in execution on a machine, and/or combinations of each to perform a function(s) or an action(s), and/or to cause a function or action from another component, method, and/or system. Component may include a software controlled microprocessor, a discrete component, an analog circuit, a digital circuit, a programmed logic device, a memory device containing instructions, and so on. Where multiple components are described, it may be possible to incorporate the multiple components into one physical component or conversely, where a single component is described, it may be possible to distribute that single component between multiple components.

“Software”, as used herein, includes but is not limited to, one or more executable instructions stored on a computer-readable medium that cause a computer, processor, or other electronic device to perform functions, actions and/or behave in a desired manner. The instructions may be embodied in various forms including routines, algorithms, modules, methods, threads, and/or programs, including separate applications or code from dynamically linked libraries.

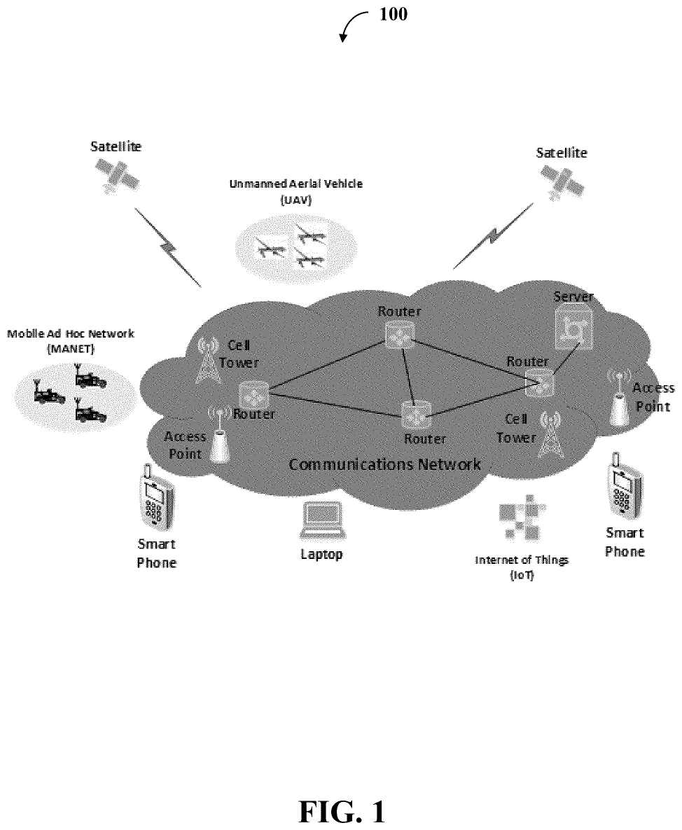

FIG. 1 illustrates one embodiment of a communications network 100. The communications network 100 can connect the end-user devices (e.g. smart phone, laptop) and network functional entities (e.g. routers, servers) to have the appropriate services. The communications network 100 can comprise wireless and/or wired links and users may be mobile and/or fixed.

The communications network 100 can employ a private permissioned blockchain, such as a private permissioned blockchain that is part of the communications network 100. Blockchain (BC) is powerful technology that can provide immutable security for transactions over the public Internet using unalterable cryptographic hashing. BC is a type of distributed ledger technology (DLT) that can record transactions between two parties efficiently and in a verifiable and permanent way. A transaction consists of a chain of blocks where individual blocks cryptographically hashed. It can be managed using a decentralized peer-to-peer (P2P) communications protocol for inter-node communication and validating new blocks. An individual block of a given transaction can be verified by a group of miners residing within the network forming a consensus of the majority miners. Once recorded, the data in a given block cannot be altered retroactively without alteration of subsequent blocks, which would have consensus of the majority of miners.

Cloud and Fog/Edge computing can be employed as a defense against cyberattacks. Response to such attacks can demand stringent real-time responses for more computation-intensive, latency-sensitive, bandwidth-intensive complex applications (e.g. real-time conversational audio and video, augmented reality) over fixed and/or mobile networks including MANETs fueled with technologies like 5G and Internet-of-Things (IoT).

A centralized cloud computing communications architecture can be used in backbone network and be employed for offering audio, video, and/or data sharing (e.g., command and control applications) services worldwide. Functionalities including artificial intelligence (AI)/machine learning (ML)/deep machine learning (DL) can be performed by the cloud computing services. The centralized cloud computing can act as a remote service.

Edge/fog computing services can be offered over access networks that can be fixed and/or mobile networks such as wireline networks, cellular wireless networks, and/or mobile ad hoc networks (MANETs). The access networks supporting edge/fog computing services can comprise a number of emerging IoT devices, high-bandwidth 5G devices, devices handling high-bandwidth videos of unmanned aerial vehicles (UAVs) networks, and/or other devices (e.g. laptops, smart phones, pads, and computers). The devices connected in the access networks can invoke a variety of computation-intensive, latency-sensitive and/or context-aware collaborative distribution applications for which fog/edge computing has emerged as the technology-of-choice for offering economies-of-scale meeting both quality-of-service (QOS) and functional requirements of various applications.

The end-to-end security of the complex networks comprising a backbone network (e.g. cloud computing) and an access network (e.g. fog/edge computing) can be important for practical deployment where the cyberattack surface is large. A blockchain-based security mechanism can be used for providing immutable security for the cloud and fog/edge computing.

Blockchain technology can be used for providing immutable security for both cloud and fog/edge computing services over the communications network 100. However, a given communications network can be architected in many different ways creating different topologies in transferring the traffic generated by the applications used between the sources and the destinations for scalability offering economies-of-scale; in this the communications network 100 is an example network up which aspects disclosed herein can be practiced. Throughout this disclosure, different kinds of network architectures are explored to understand that use the same basic blockchain principles for providing the immutable security for cloud and fog/edge computing services despite the network can have different architectures and topologies meeting both QOS and functional requirements of applications between the source and destination entities for communication networks.

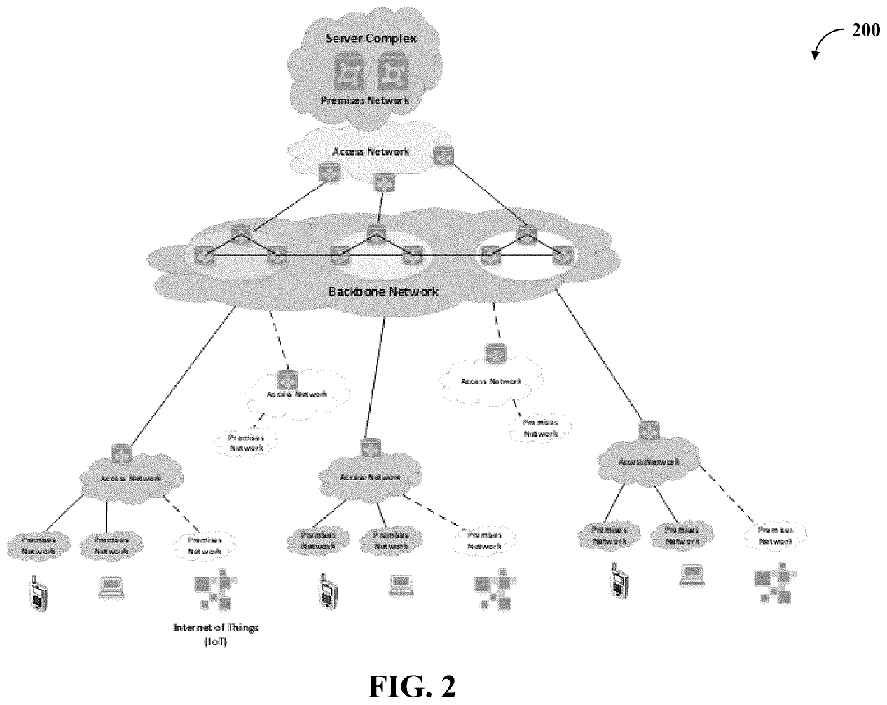

FIG. 2 illustrates one embodiment of a schematic view 200 of a large-scale hierarchical communications network. The view 200 can be for the communications network 100 of FIG. 1 as the large-scale hierarchical communications network. In one example, large-scale hierarchical communications network can comprise a backbone network that connects multiple access networks with the individual access networking connect one or more premises networks.

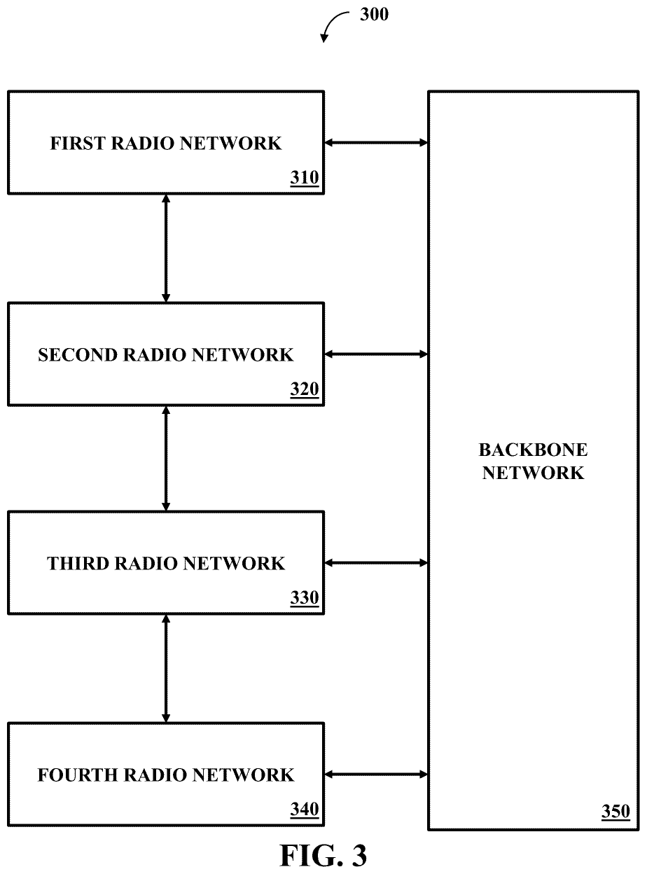

FIG. 3 illustrates one embodiment of a high-level view 300 of a communications network. The communication network can have multiple radio networks—four are illustrated as radio networks 310-340—along with a backbone network 350. The radio networks can implement—individually, combined, or in part—as all or part of the communications network 100 of FIG. 1. The communications network can be employed for command and control applications, such as commercial applications.

Example network functional entities for the communications network can include mobile ad hoc networks (MANETs), sensors/internet-of-things (IoT), unmanned aerial vehicles (UAVs), and others. These can also be used in commercial networks, albeit at times for different purposes. The network architecture for the communications network can be mapped logically, into backbone, access networks, and premises networks. In one example implementation, the first radio network 310 can be for people on foot, the second radio network 320 for ground vehicles, the third radio network 330 for water vehicles, the fourth radio network 340 for air vehicles; the backbone network 350 can unify these to work together.

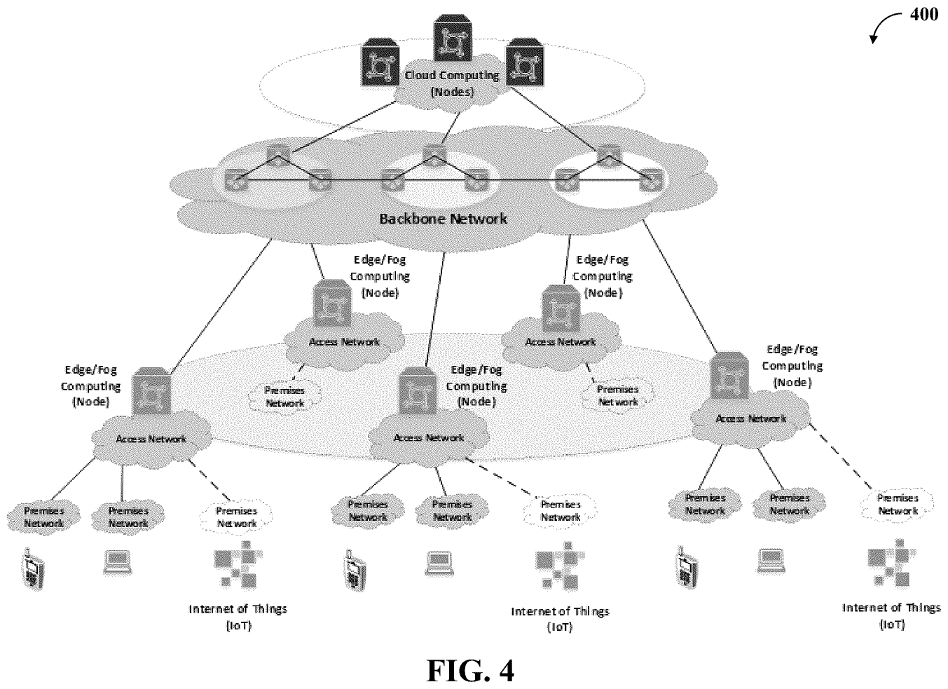

FIG. 4 illustrates one embodiment of a high-level logical view 400 of cloud and fog/edge computing services over a communications network. Cloud and fog/edge computing can be a unified platform transparent to the end-users. A client/user can receive their computing services based on their services requirements. An individual client/user can access a single point of the access network from its premises network without knowing whether computing services are coming from the fog/edge computing node or from the cloud computing node. The cloud and fog/computing can be the services that are offered over the communications network 100 of FIG. 1. With this there can be a general idea of logically centralized cloud computing services that are offered over the backbone network while the distributed fog/edge computing services are offered over the access networks.

Individual computing resources like servers, storages, databases, networking, application software, analytics, services, and intelligence over the Intent can be placed in different locations by a service provider. These can be highly underutilized using a simple resource-sharing model and are incapable of taking full advantage of the bustiness characteristics of the traffic through intelligent statically multiplexing.

Cloud computing that virtualizes the resources for statistically multiplexing of busty traffic intelligently for efficiently utilization of computing resources can be a powerful model for delivery of computing services. Through virtualization, cloud computing can be able to address with the same physical infrastructure a large client base with different computational desires. Cloud computing can be, in one embodiment, service-oriented instead of application-oriented. The cloud computing model offers convenient, on-demand network access to a shared pool of configurable virtualized computing resources (e.g., networks, servers, storage, applications, services, and intelligence) that can be rapidly provisioned and released with minimal management effort or service provider interaction.

Cloud computing can be modeled to provide high powerful resources for computing, storage, the environment of application development with multiple platforms with ease of management and coordination of devices of resources at one place (or more than one place when appropriate). Accordingly, the cloud computing services can be architected with categories of services such as software as a service (SaaS), Platform as a service (PaaS) and Infrastructure as a Service (IaaS) making the services highly scalable offering economies-of-scale. The characteristics of these three cloud computing services are defined below: SaaS can deal customer services like accounting, database application software and emails but the user did not deal with technical infrastructure of cloud. PaaS can provide a platform for application developer like programming environment, by using those tools develop applications and have rights configure and technically manage the cloud. IaaS can provide services of the infrastructure of clouds such as manage servers, storage and network devices. IaaS can provide the right to manage, change or configure cloud infrastructure according to their desires.

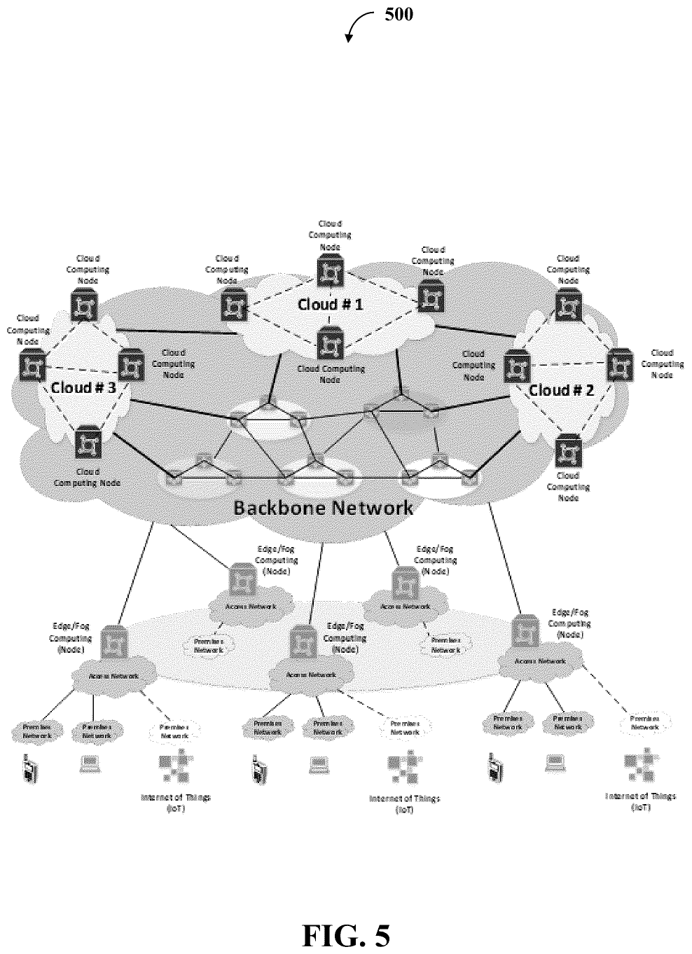

FIG. 5 illustrates one embodiment of multiple cloud computing systems over a backbone network 500. The backbone network 500 can be a large-scale backbone network that is an implementation of the communication network 100 of FIG. 1. The backbone network 500 can have multiple cloud computing systems in order to handle the traffic loads making the backbone network more scalable offering more economies-of-scale. The backbone network 500 can have a cloud computing communications network architecture that has multiple clouds (e.g. cloud #1, cloud #2 and cloud #3).

In case of multiple clouds, there can be peer-level inter-cloud communications. A suitable peer-to-peer (P2P) application layer can be used for inter-cloud protocol. In one example, P2P session initiation protocol (P2P-SIP) can be one of the candidates which can be used as the Inter-Cloud Communications Protocol.

Aspects disclosed herein can be practiced with differing kinds of multi-cloud computing architectures such as Multi-Cloud or Hybrid Cloud Architecture that can comprise Public Cloud, Private, and Enterprise Cloud or with variations of this where these clouds are controlled by different owners or stakeholders or carriers. However, a third party such as. Internet Service Provider (ISP), can develop a common network interface that connects these clouds of different ownerships and packages the clouds as unified cloud computing services to the end-users/customers. The third party/ISP can offer the cloud computing services from these cloud providers that are transparent to the customers/end-users. The BC-based cloud computing services discussed herein can be used individually between the users and the sellers depending on who are the users and who are the sellers. In one example, the third party/ISP in this example can be the user while the individual cloud providers can be the seller. So, the BC and Smart Contract-based concept proposed can provide immutable secured proactively-executed cloud computing services.

Fog/edge computing can be employed to complement the cloud computing services. In this respect, access to a computing services by a client can be provided via the fog/edge nodes in the respective access/premises networks distributed across different geographical locations. However, the actual services provided either by the fog/edge or cloud computing services can be decided using the service requirements of the clients. So, which computing nodes offer the services either by a fog/edge node (server) or by a cloud node (server) is transparent to the client.

Fog/Edge computing can utilize resources of devices on edge complementing the cloud computing services. Fog/Edge computing can have its own characteristics to process data burdens and preferences and be a supplement to cloud computing. Fog/Edge computing can be modeled as a progressed or expanded variant of cloud computing where the computing happens at the edge of the system. Cloud computing can be a centralized system, while the fog/edge computing can be a distributed decentralized infrastructure fulfilling the demands of stringent performance desires for the real-time applications including avoiding of unpredictable network overload and transmission latency. In this way, fog is an intelligent gateway that offloads clouds enabling more efficient data storage, processing and analysis.

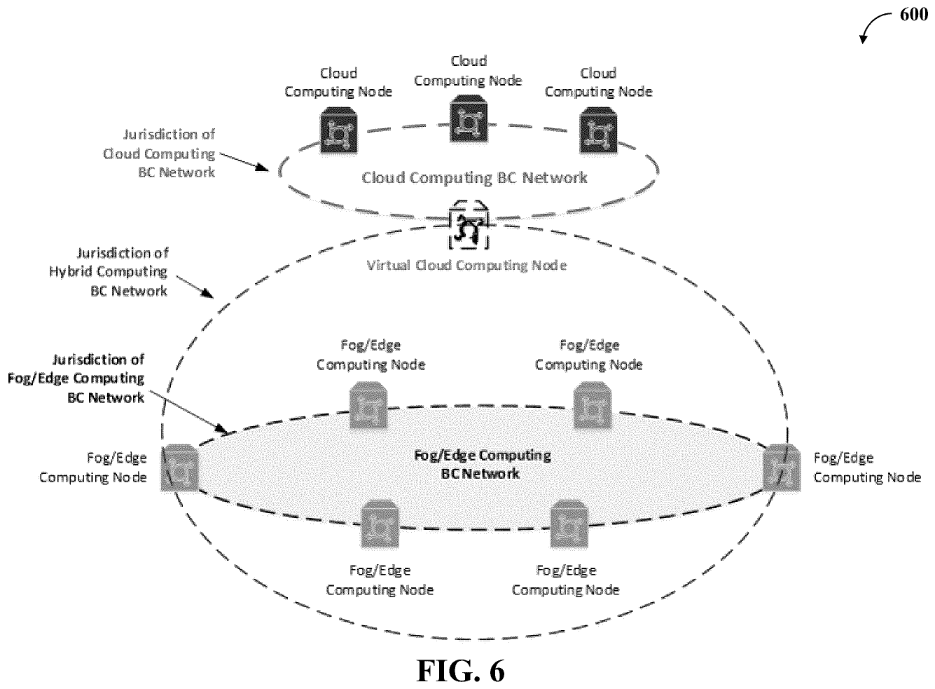

FIG. 6 illustrates one embodiment of a logical view 600 of a cloud, hybrid computing, and fog/edge computing blockchain network with a single cloud. Members of the cloud computing BC network can comprise cloud computing node(s) and virtual cloud computing node(s). Members of the fog/edge computing BC network can comprise fog/edge computing node(s). Members of the hybrid computing BC network can comprise the virtual cloud computing node(s) and the fog/edge computing node(s). The cloud, hybrid computing, and fog/edge computing blockchain network can have service requirements, such as service requirements for end-users (e.g., devices) connected to premises/access networks that are released by fog/edge computing nodes. Access control of the cloud, hybrid computing, and fog/edge computing blockchain network can be done by the fog/edge computing nodes for the user that belong to the respective access networks including private key and public key management along with real-time responses (e.g., exclusively done by the fog/edge computing nodes). A fog/edge computing node can function with its own local server.

The private permissioned blockchain can be employed for the cloud, hybrid computing, and fog/edge computing blockchain network and work with cloud and fog/edge computing services. Machine-to-machine (M2M)/device-to-device (D2D) communications, Internet-of-Things (IoT) with intelligent nano-technology-based sensors and addressable software entities, and supporting many mobile and fixed users across the globe, logically centralized cloud computing can act as a remote service and may have difficulty meeting the stringent performance requirements of real-time audio/video conversational and context-aware applications. To address this, the cloud computing services can include a “single” cloud over the backbone network. In one example, a single cloud can offer computing services over the entire backbone network.

Distributed fog/edge computing can include mobile edge/cloudlet computing. This can satisfy stringent performance requirements such as end-to-end delay, delay jitter, and others of these applications. The functionalities can be separated between the cloud and fog/edge computing. The cloud computing can, in one embodiment, primarily provide three kinds of high-throughput-capacity services concentrated at one place for each customer, such as, SaaS, PaaS, and IaaS acting as the backend of the fog/edge computing. Meanwhile, the fog/edge computing can, in this embodiment, support the other applications directly to the end users in real-time when the calls arrive meeting stringent real-time performances (e.g. end-to-end delay, delay jitter) including avoidance of unpredictable network overloads and transmission latency using distributed collaborating computing services model.

A computing architecture can be employed where the cloud computing over the backbone network is logically centralized, but physically distributed over the backbone network while the fog/edge computing is completely distributed supporting the end-users directly working collaboratively among the fog/edge computing nodes located in different access networks. The cloud computing can work as the remote backend of the fog/edge computing supporting the customers who have large (e.g., the highest) computation-intensive functions with high throughput-capacity concentrated in one place. As a result, the fog/edge computing being nearer to the customers can fulfill the demands of stringent real-time responses for both computation-intensive and latency-sensitive applications (e.g. real-time conversational audio/video, augmented reality, mixed reality) that benefit from the avoidance of unpredictable network overload and transmission latency including users connected in mobile ad hoc networks. Without the fog/edge computing, remaining far away from the customers, the centralized cloud computing that has also a single point-of-contact, may struggle to meet both performance and reliability requirements.

In logically centralized cloud services, there may be many cloud computing servers located in many physical locations over the backbone network. However, a particular cloud computing server that is located nearest to the fog/edge computing node can provide services for load balancing and to meet performance requirements making the cloud computing services scalable, thereby, providing economies-of-scale. In this respect, the fog/edge computing nodes can have a single point of contact for requesting cloud computing services, as if, the cloud computing services are logically centralized. In practice, however, a given physical cloud computing server can serve a particular service request.

Aspects disclosed herein can be employed to offer computing services with using a single BC network or multiple BC networks. In general, the working principles of one or multiple BC networks can be the same or similar. However, to design multiple BC networks in differentiating the computing services desires (e.g., requirements) and making the network operations scalable offering economies-of-scale can benefit from more than a single BC network that may lack the intelligence to take advantages of differentiated services. In view of this, the design principles for the multiple BC networks having the intelligence for differentiations of services offering scalability can be employed and a subset of these design principles can easily be applied to create a single BC network. This allows for design principles of multiple BC networks for providing differentiated computing services.

When there are distinct divisions of computing services across the backbone network and the access networks for achieving economies-of-scale, three logically separate independent blockchain networks can be employed, as well as more or less depending on circumstances. The three networks can be cloud (e.g., single) computing BC network, fog/edge computing BC network, and hybrid computing BC network.

The Cloud Computing BC Network can function as logically centralized, but with physically distributed cloud computing nodes (e.g., servers). The members of the Cloud Computing BC Network include the cloud computing physical servers (e.g., nodes) of the Backbone Network plus a Virtual Cloud Computing Node (e.g., a single virtual cloud computing node). The Virtual Cloud Computing Node can abstract the logically centralized cloud computing services provides by the cloud computing physical servers of the Backbone Network.

Once the virtual cloud computing node is assigned for offering cloud computing services, it can broadcast the service requirements among the cloud computing nodes using a Smart Contract. The cloud computing nodes can offer bids to offer services cost-effectively in meeting the performance standards (e.g., requirements). The winner is the one that offers services with lowest cost in meeting performances, and miners of the cloud computing BC nodes stored the contract of the winner after validation with a chain of blocks using cryptographic hashes that are irreversible proving immutable security and the parties can verify it.

The Fog/Edge Computing BC Network can comprise the Fog/Edge Computing Nodes of the Access Networks. The Fog/Edge Computing Nodes can offer distributed computing services working collaboratively in meeting the real-time responses.

The Hybrid Blockchain Network can comprise fog/edge computing nodes and the Virtual Cloud Computing Node. The general working principles of the hybrid BC network can be the same or similar as described for the Cloud Computing BC network above.

The general working principles of these BC networks can be the same. A BC network can, in at least one embodiment, function as a signaling network because a BC network can keep the distributed immutable secured hyper-ledger of a chain of blocks that contain the header information of a set of the transactions, not the actual payload traffics that the transaction carries. The actual payload traffics of transactions can be directly sent between the source and destination node bypassing the BC networks. Although the general working principles for the cloud, hybrid, and fog/edge computing BC networks can be the same, individually the BC networks can work independent of each other logically.

The cloud and fog/edge computing nodes can have to have IP router functionalities. The routing functions can be integrated with the individual computing nodes including the Virtual Cloud Computing Node or connected to a router (e.g., this can depend on how routing functionalities are implemented.

The cloud and fog/edge computing nodes, having IP functionalities either directly or indirectly, can be able to run the application layer P2P blockchain signaling protocol on the top of the IP network layer. These BC networks can also work using application layer P2P BC signaling protocol over the network layer IP protocol.

The virtual cloud computing node can be used as the single point of contact and can work as a virtual gateway through which the cloud computing services can be offered. However, the actual physical servers that offer the computing services can be geographically distributed in different geographical locations across the backbone network. Since the cloud computing services are offered for a single point of contact from outside it provides the appearance of the cloud computing as a centralized service, albeit, it is actually logically centralized.

The realization of a single point of contact with an address for communications to the cloud computing services can be realized in many different ways making the cloud computing services scalable. For example, it could be one of the physical cloud computing server (node) or one of the other proxy cloud computing node that initially receives the call from the fog/edge computing node, and then decides among the cloud computing nodes (servers) which physical computing node (server) will actually be able to serve this call cost-effectively meeting the performance requirements, and send the address of that particular cloud computing server (node) that will serve the call.

When a service requests come through the virtual computing node, a negotiation can happen among the cloud computing physical servers located at different physical locations to find out which physical server is preferred (e.g., is the most cost-effective based on traffic load, performance, and distance to offer computing services that a given specific customer has requested). A suitable application layer negotiation protocol, for example, peer-to-peer (P2P) session imitation protocol (SIP) (P2P-SIP) carrying the BC smart contract, can be used for this purpose among the cloud computing servers including the virtual cloud computing node.

The fog/edge computing node of a given access network through which a customer communicates from his/her premises network can act as a single point of control for security and computing services. So, the fog/edge computing node can be the same one whether actual computing services are offered either by the cloud or by the fog/edge computing node is transparent to the end-user/customer. Consequently, the application layer negotiations protocol (e.g. P2P-SIP) that is used between the computing servers is transparent to the end-user/customer. This is due to the fact that the actual communications with the customer/end-user can still happen via the same fog/edge computing node through which the customer/end-user first sends the computing service request.

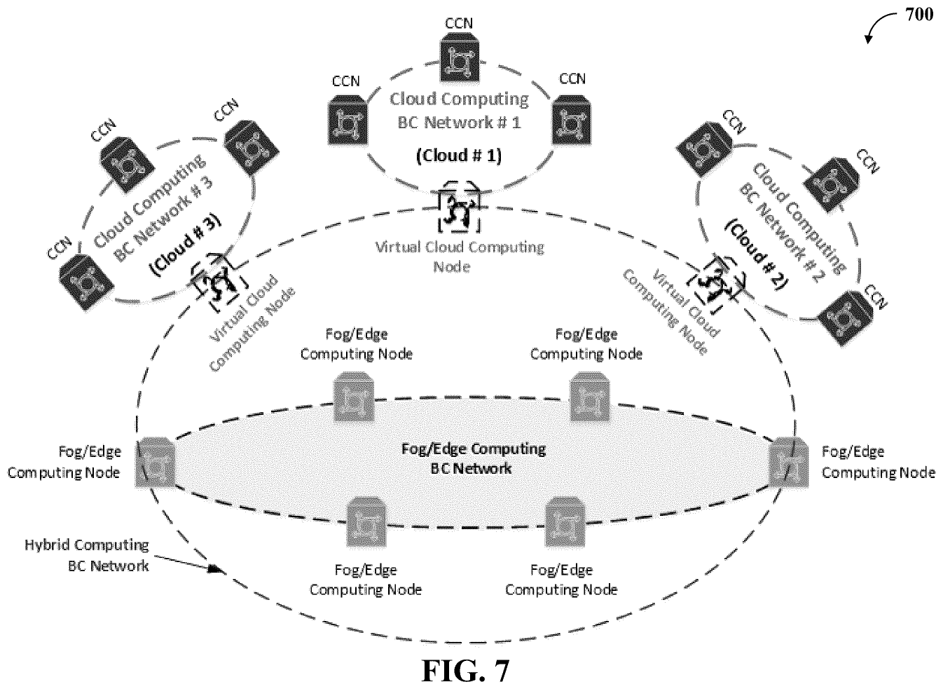

FIG. 7 illustrates one embodiment of a logical view 700 of a cloud, hybrid computing, and fog/edge computing blockchain network with multiple clouds over a blockchain network, with three clouds (Cloud #1, Cloud #2, and Cloud #3) with their own set of Cloud Computing Nodes (CCN). The cloud computing BC network (e.g., Cloud #1, Cloud #2, or Cloud #3) can comprises the cloud computing nodes and the virtual cloud computing nodes (e.g., of Cloud #1, Cloud #2, or Cloud #3). The hybrid computing BC network can comprise the virtual cloud comping nodes and the fog/edge computing nodes. The fog/edge computing BC network can comprise the fog/edge computing nodes. Service desires (e.g., requirements) of end-users connected to the premises/access networks can be released by the fog/edge computing nodes. Access control can be performed by the fog/edge computing nodes for users that belong to the respective access networks including private key and public key management along with real-time responses.

When there are multiple clouds over the backbone network, an individual cloud can appear to be logically centralized, but physical severs (e.g., nodes) that provide computing servers can be distributed at different geographical locations over the backbone network. The logical view 700 can be a high-level logical view of BC Networks with multiple clouds over the backbone network.

In terms of BC, an individual Cloud can have its own independent Cloud Computing BC Network (e.g. cloud #1, #2, or #3) and have a single Virtual Cloud Computing Node. However, these Virtual Cloud Computing Nodes can be the member of the Hybrid Computing BC Network.

A fog/edge computing node can remain in control of a computing service, which has received the call from the end-user/customer. If the customer requires to be served with cloud computing services, a decision can be made on which cloud offers the service. The fog/edge computing node that is in control of the call can broadcast the services desires (e.g., requirements) using, in one embodiment, a Smart Contract over the Hybrid Computing BC Network, and the virtual cloud computing nodes can offer bids to serve the call cost-effectively in meeting the services desires. The lowest price bid that meets the service requirements including the performances can be chosen and miners of the Hybrid Computing BC networks can validate the bid in storing the results in the BC network that members can verify. The corresponding cloud that is the winner of the bid can offer the computing services.

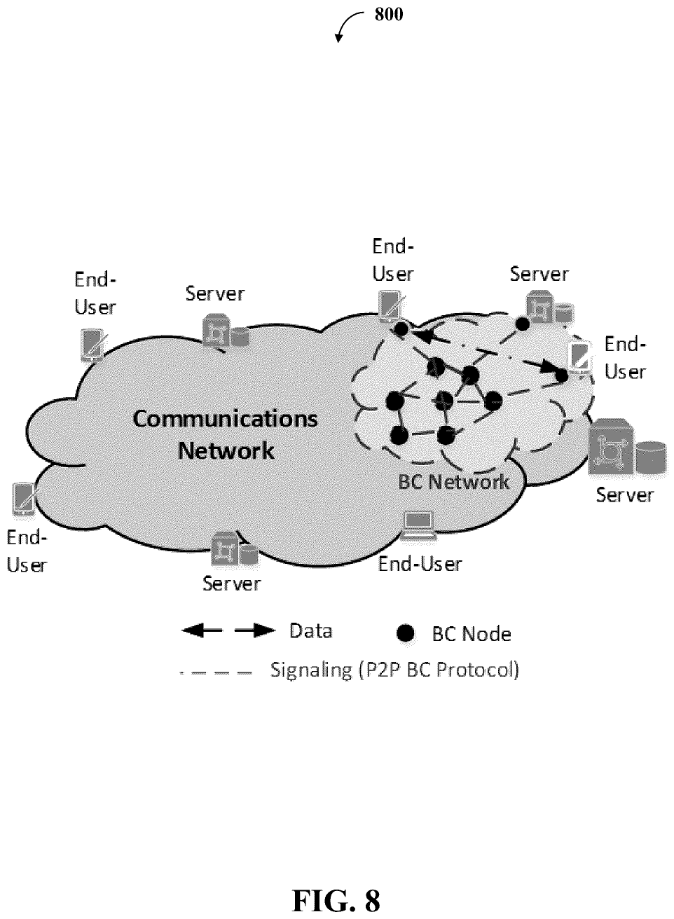

FIG. 8 illustrates one embodiment of a high-level view 800 of a blockchain overlay network over a communications network. The communications network can be an enterprise (e.g. commercial) communications network that can be designed logically to have an architecture comprising a wide area backbone network, such as a single wide area backbone network, and different access networks covering a vast geographical area, even to include the entire globe. Further, even there can be many different end-user/customer premises networks where end-users'/customers' devices are connected where a group of premises networks to a single or multiple access networks as appropriate to provide economies-of-scale. The communications network can offer computing services that can be architected as cloud computing over the backbone network and fog/edge computing over the access networks.

A BC mechanism can be employed to provide immutable security for transactions of the computing services to the end-users/customers where the end-to-end communications network topology can comprise a backbone network, access networks, and numerous premises networks. A BC network can be a signaling network using an application layer P2P (e.g. P2P-SIP) protocol.

Unlike public Bitcoin BC network whose management is decentralized, a permissioned BC network is managed by an authority such as an owner of commercial networks. The BC nodes that form the BC network are permitted by the controlling authority. End-users/customers receive permission from the controlling authority to connect their devices to the BC network.

Functional entities (e.g. end-user device, router, server, cloud computing node, fog/edge computing node) that support the P2P BC protocol functionalities can be defined as BC node. The BC network and a non-BC network can function together in a flexible matter, but it does not bar a network entity from being a BC node if the said entity desires to be one (e.g., through a type of BC software update).

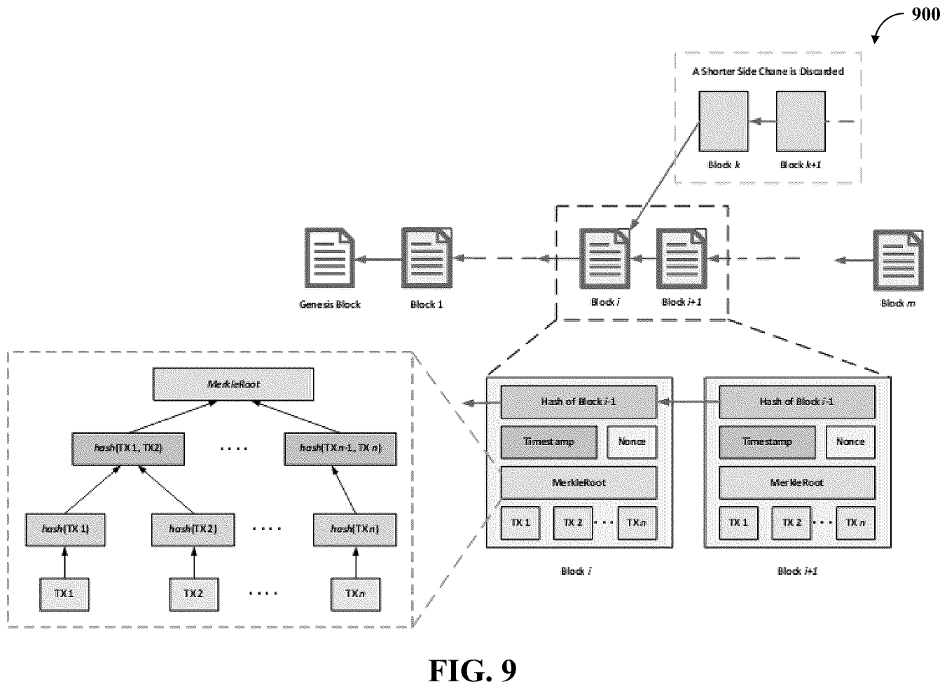

FIG. 9 illustrates one embodiment of a blockchain working flow 900. The flow 900 can be the working principles of a blockchain. A blockchain can be a continuously-growing chain of blocks. When a new block is generated, the nodes in the network can participate in validating the block. Once the block is validated, it can be appended to the blockchain.

To validate the trustfulness of blocks, consensus algorithms can be developed. Consensus algorithms can determine which node to store the next block and how the new appended block to be validated by other BC nodes. Representative consensus algorithms can include a proof of work (POW). The BC node that takes part in validation can be called miner. A miner can keep a full copy of the blockchain. The distributed consensus algorithms can ensure that transactions are done without the intervention of third parties like banks. As a result, the transaction costs can be saved. Moreover, users transact with their virtual addresses instead of real identities so that the privacy of users is also preserved.

Different consensus algorithms, such as Proof of Work (PoW), Proof-of-Authentication (PoAh), and others, can be used for the private blockchain network to meet the performances and functional desires for cloud and fog/edge computing services. The applications that can be designated for use in the cloud computing services can be backend services of the fog/edge computing services where no end-users are involved. However, the fog/edge computing can offer direct services to the end-users where stringent real-time responses are appropriate for the distributed collaborative applications. The fog/edge computing blockchain network can have some additional features specific to end-user distributive collaborative applications. Consensus algorithms such as PoW, PoAh, and others can be modified to meet the real-time responses. In one example, central processing unit (CPU) processing time can reduced to meet the real-time responses by changing the accuracy requirements in finding the match of hashes varying nonce values for PoW.

In blockchain systems, it is possible that several nodes can successfully reach the consensus at the same time, consequently it can cause the bisected branches. To solve the disparity, a shorted side chain can be desolated while the longest chain can be selected as the valid chain. This mechanism is effective since the longer chain than it can be more tolerant to malicious attacks than a Smart Contract.

Smart contracts can have two important features: automation and non-repudiation, which can be self-executed proactively (e.g., automatically) once it is triggered by some events (e.g. data/traffic update and time) that happens in the cloud and fog/edge computing services. The BC network can provide a smart contract with new properties, for example, decentralization having communications using peer-to-peer (P2P) application protocol and transparency irreversible cryptographic hash-based immutable secured transactions. Smart contracts can be designed with desired algorithms that can meet real-time responses requirements.

A smart contract is a computer protocol acting like an “autonomous agent” stored in the blockchain network. It is encoded as part of a “creation” transaction that introduces a contract to the blockchain and intended to digitally facilitate, verify, or enforce the negotiation or performance of a contract with credible transactions without third parties.

Once successfully created, a smart contract can be identified by a contract address, can hold some amount of virtual (e.g., digital) coins, can have its own private storage, and can be associated with its predefined executable code. A contract state can comprise two main parts: (a) a private storage and (b) the amount of virtual (or digital) coins it holds termed as balance.

The smart contract has the following features: Autonomy, Trust, Backup, Safety, Savings, and Accuracy. For autonomy, Smart contract execution between the parties/clients can be managed proactively by the BC network without a third party. For trust, smart contract documents can be encrypted on a shared ledger and stored in the BC network, which can be verified (e.g., verified anytime guaranteeing non-repudiation with no chance being lost). For backup, contract documents can be stored in many places of the BC network. For safety, cryptographically irreversible BC hashes of the documents can provide immutable security against hacking. For savings, there is no need for a third party like bank, notary public, or magistrate for the smart contract executions. For accuracy, there can be automated smart contracts that can be avoid the errors that come from manually filling out heaps of forms.

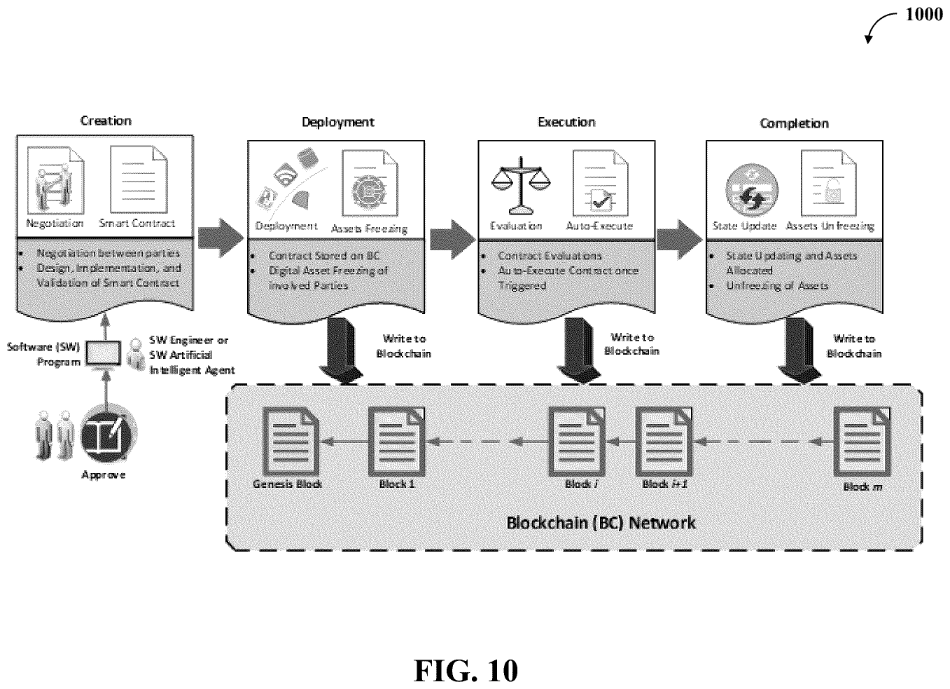

FIG. 10 illustrates one embodiment of blockchain phases 1000 of a smart contract: creation, deployment, execution, and completion. Currency in the private permissioned BC network can be analogous to the number of addressable devices or functional entities over the BC network, and the reward can be equivalent to the immutable security services that are offered for the transactions. The whole life cycle of smart contracts can be the phases 1000.

The creation of the Smart Contract phase can be that the smart contract is created through iterative negotiations among the parties involved including lawyers. The final contract can be written in a computer program by a programmer, which may include declarative and logic-based rule languages.

The deployment of Smart Contract can occur through validation by the miners of the BC network. Once the contract is stored as immutable irreversible hash-based blocks of a chain in the BC network, parties can access the smart contract. Moreover, digital assets of the involved parties in the smart contract can be locked via freezing the corresponding digital wallets that work like bank's safety deposit boxes, but using digital cryptographic keys where parties can be identified using by their digital wallets.

Execution of the smart contract can comes after the deployment of the smart contract. During deployment, the contract can be monitored and evaluated by the relevant parties. Once the contractual conditions are satisfied (e.g. obtaining the services of the cloud), the contractual procedures or functions can be proactively executed triggered by declarative statements with logical connections. Consequently a transaction being executed and validated by a miner can be stored with its updated states in the blockchain network thereafter.

Completion of the smart contract can begin when new states of the involved parties of the smart contract are updated after the execution of the contract. Meanwhile, the digital assets can be transferred from one party to another party (e.g. money transfer from the buyer to the supplier). Consequently, digital assets of involved parties can be unlocked. The smart contract then has completed the whole life cycle. Each sequence of transactions as shown in FIG. 10 can be stored in the BC network including the completion.

For digital currency, coins can be analogous to devices that deal with the kinds/types of transactions (e.g. amount of traffics, performance/QOS requirements) and rewards can be analogous to security services received by devices and transactions. There can be a lot of different mechanisms how the traffic/QOS and security of a transaction of cloud services can be transformed to digital assets lie digital coins.

The customer/end-user can use computing services that employ the smart contract having the BC network interface ensuring end-to-end immutable security for the automated transactions without involvement of third party or manual intervention. In this respect, a customer/end-user can be a variety of terminals (e.g. smart phones, laptops, and hand-held devices), sensors, IoT, and many others. The idea is that these functional entities can be be capable of using BC-based smart contracts. However, these can use peer-to-peer (P2P) BC signaling protocol (e.g. P2P Session Initiation Protocol [P2P-SIP]). With respect to use of P2P-SIP protocol, commercial networks can use SIP protocol for real-time applications like voice-over-Internet protocol (VOIP) and others. SIP protocol can be considered a subset of P2P-SIP, and it can incur a small implementation cost including operation and maintenance (O&M) on the top of the existing networks.

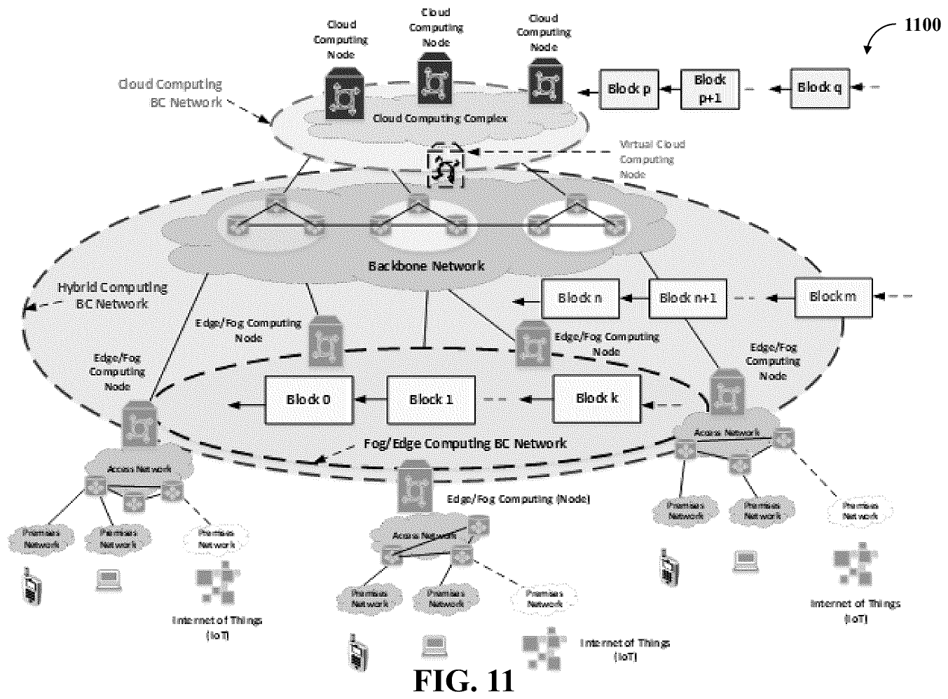

FIG. 11 illustrates one embodiment of a high-level view 1100 of blockchain-based cloud and fog/edge computing layers. In a hybrid computing blockchain network can overlap the cloud layer and the fog/edge computing layer. With this, there can be a premises networks layer that can connect the end-user/customer devices used for having computing services

An access networks layer can connect the premises networks, where the distributed collaborative fog/edge computing services are offered to the end-users (devices). Computing services can be requested via the fog/edge computing node as the point of contact. Whether the computing services are offered by the fog/edge computing node can be transparent to the end-user/customer. A Fog/Edge Computing BC network that resides in this layer can comprise the fog/edge computing nodes of access networks.

A backbone network layer can connect the access networks, where the logically centralized computing services can be offered remotely to the fog/edge computing nodes. A cloud computing BC network that resides in this layer can comprise the cloud computing physical severs (nodes) that are located in different geographical locations of the backbone network plus the Virtual Cloud Computing Node.

A hybrid computing BC network can overlaps the access network layer and the backbone network layer. The hybrid computing BC network can comprise the fog/edge computing nodes of the access networks plus the Virtual Cloud Computing Node. Although fog/edge computing nodes and the virtual cloud computing nodes are the members are part of two logically separated BC networks, these two BC networks can work independently. Similarly, the fog/edge computing nodes and the virtual cloud computing node can simultaneously be members of two logically separated BC networks and work transparently.

The three blockchain networks can be superimposed over the three-layer cloud and fog/edge computing architecture. The high-level view 1100 depicts the resultant three-layer BC-based Cloud and Fog/Edge Computing network architecture. It can be the same 3-layer architecture where the cloud computing BC network covers the cloud computing backbone network layer and the fog/edge commuting access networks layer while the fog/edge computing BC network covers the fog/edge commuting access networks layer (e.g., only the fog/edge commuting access networks layer).

The cloud computing services can be logically centralized while the fog/edge computing services can be distributed. In logically centralized cloud services, there can be many cloud computing physical servers located in many different geographic locations over the backbone network in support of the fog/edge computing nodes for providing very high computation-intensive services remotely in a single location of each customer.

However, a particular cloud computing server that is located nearest to the fog/edge computing node can provide computing services for load balancing and meeting performance desires making the cloud computing services scalable, thereby, providing economies-of-scale. In this respect, the fog/edge computing nodes can have a single point of contact for requesting cloud computing services, as if, the cloud computing services are logically centralized. In practice, however, a given physical cloud computing server can be configured to serve a particular service request.

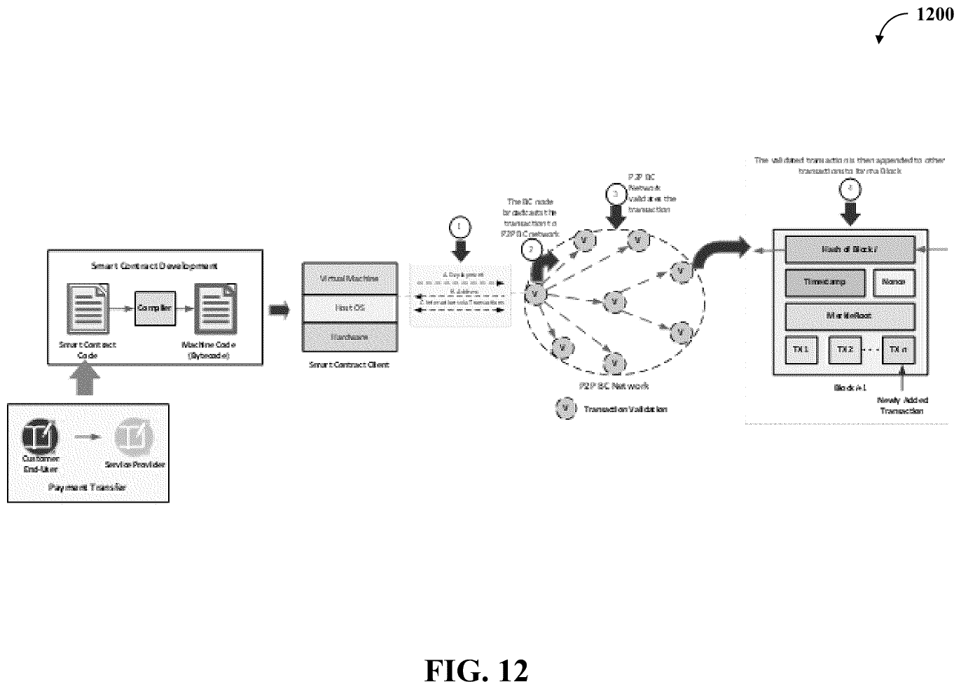

FIG. 12 illustrates one embodiment of a workflow 1200 of a smart contract. Fog/Edge computing nodes can be organized as coalitions for forming the Fog/Edge Computing BC network, with the coalitions can be incentivized to act as a miner for maintaining the BC-based hype-ledge with regard to the smart contract. Dynamic collaborative fog/edge computing negotiations can be achieved through smart contract, enabling incentivizing competitions and collaborations for fog/edge computing tasks without relying on the centralized authority. The end-users/customers can be capable of verifying the computing services results while misbehaving fog/edge computing nodes can be punished proactively.

A fog/edge BC node that has received a call from an end-user/customer requesting computing tasks can have the sole responsibility to control the call acting as the sole point-of-contact (POC) for the end-user/customer. So, the request for computing tasks that have been submitted by the end-user/customer can be performed in the Access Network Fog/Edge cloud or in the Backbone Network cloud depending on the specifications of the tasks. In one embodiment, the fog/edge computing node can decide that the call can be served by the fog/edge cloud based on the service specifications.

The computing services negotiations using smart contracts can be a part of the execution of smart contracts, such as when smart contracts are deployed over the fog/edge computing BC network. This can be practiced in accordance with the workflow 1200.

In one example, a contract of money transfer between the end-user/customer and the Service Provider with the workflow 1200. After several rounds of negotiations, the agreement between the end-user/customer and the service provider can be reached. Then the agreement can be implemented by a smart contract language. The smart contract code can be compiled via a compiler, which generates, for example machine code or bytecode running on top of either virtual machines such as Java Virtual Machine (JVM) or Docker containers at a smart contract client. The smart contract client can be connected through a peer-to-peer (P2P) network, for example P2P-SIP. After the smart contract is deployed across the BC network, a unique contract address can be returned to the client to support the future interactions. Thereafter, users can interact with the BC network via executing transactions in the smart contract.

In one example of use of the workflow 1200, there can be deducting the specified amount of money that is transferred from the end-user/customer to the service provider from end-user/customer's digital wallet and increasing the corresponding amount of money in service provider's wallet. An individual transaction can be validated across the BC network via consensus algorithms. The validated transaction can be appended to a list of transactions. When a node set (e.g., every node) has a copy of the updated BC, it can be difficult to falsify the BC data.

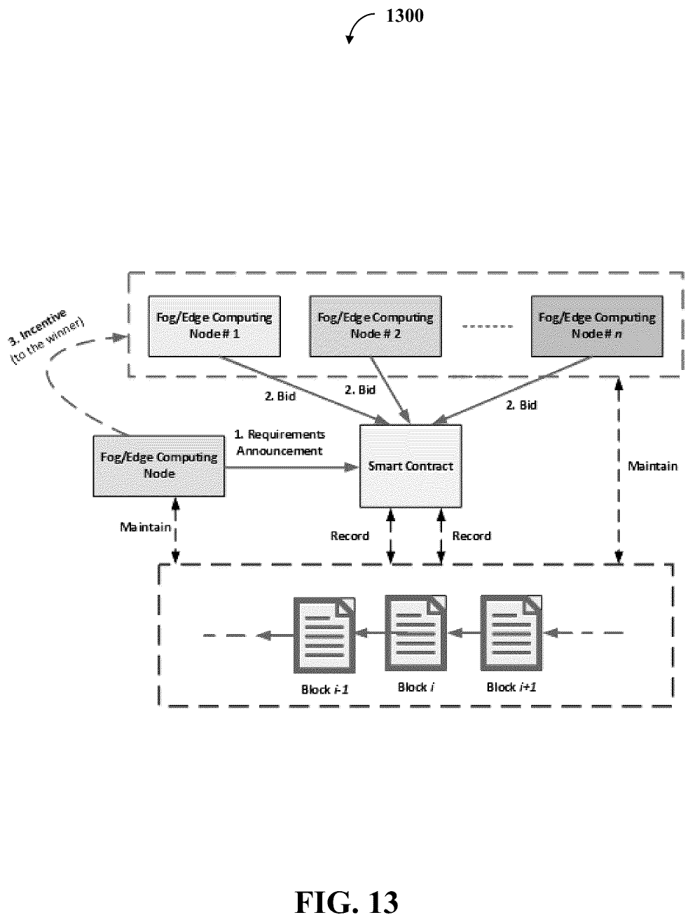

FIG. 13 illustrates one embodiment of a flow 1300 of dynamic negotiations in blockchain nodes. Services can be negotiated over the fog/edge computing BC network using smart contracts. The fog/edge computing BC network can enable trusted dynamic negotiations in terms of desired computing services, employing smart contracts without relying on a centralized authority.

The computing service desires can be released to the end-users/customers by the fog/edge nodes and the creation and approval of service agreements can be auto-executed between the end-use/customer and the service provider using smart contracts and stored in the BC network. Once the service agreement described in the smart contract is approved, an end-user/customer can then place a call to the fog/edge computing node using the smart contract requesting the computing tasks. The fog/edge node can broadcast the task requirements using the smart contract among the candidate fog/edge computing nodes over the Fog/Edge computing BC network as illustrated by the flow 1300. The request can include, in one example, the specifications of the computing tasks including performance/quality-of-service (QOS) requirements and expiration, in which incentives can also be carried to attract more fog/edge node participation. Participating fog/edge computing nodes can reply back sending the bids recording their costs and capabilities (e.g. computing capabilities, processing times, and end-to-end delays) receiving the task order. The fog/edge computing node requests and replies can be recorded in the fog/edge computing BC network in the form of smart contracts, where the fog/edge computing node that send the reply with preferred (e.g., lowest cost with higher capabilities—such as higher computing capabilities, lowest processing time, and lowest-end-to-delay) is selected as the bid owner. This can also trigger smart contract execution to proactively transfer incentives (e.g., rewards) to the winner.

The fog/edge BC network can have built-in accountability that rewards (e.g., incentivizes) distributed fog/edge BC nodes to verify the collaborative results for computing task that has been requested by the end-user/customer. Based on the dynamic fog/edge computing nodes' negotiations, the winner can be allocated to the computing tasks. Then the winner fog/edge computing node can process the job and feed the results back to the end-user/customer. The controlling fog/edge computing node can be in the loop if it itself is not the winner. These transactions can be recorded in the fog/edge computing BC network after one block or more block time. The P2P BC application layer protocol (e.g. P2P-SIP) can make sure that the controlling fog/edge computing node is in the loop even if it is not the winner of the bid.

The recorded transactions of the completed tasks including the feedbacks/responses over the BC network about the completed tasks from the end-user/customer can be verified by the fog/edge nodes to check whether any untrusted behaviors of fog/edge nodes including the node that has completed the tasks. In one example, customer's feedback reports can have the record whether the completed tasks have met the QOS standards (e.g. throughput rate, end-to-end delay, delay jitter) and services features like quality-of-Experience (QOE) (e.g. delight or annoyance) of the customer.

When these verification results are recorded on the BC network, smart contracts can be triggered, causing some previously stacked rewards of the winner if the job completion report is not satisfactory, and the collected rewards (or security deposits during bidding time that we add in bidding if appropriate) can be distributed to other honest computing nodes to incentivize them. In this way, the decentralized accountability built in the BC network can hold the computing nodes accountable for delivering the untrusted results of the completed tasks while rewarding the nodes for security/trust verifications.

A trust reputation system can be employed for an individual fog/edge computing node, providing an authoritative reference for the trustworthy selection of stakeholders (e.g. bid winner). Using BC network, operations (e.g. negotiations and verifications) can be openly recorded and obtained by the BC computing nodes (e.g., stakeholders). In this case, the participating fog/edge computing nodes can be credibly evaluated according to the decentralized verifications for their previous submitted results for tasks completion.

The trust reputation system can use a metric set comprising reputation, knowledge, and experience for a fog/edge computing node. Experience and knowledge can be defined as the trust indicator (TIs) based on evidence using the measurements associated with the behavior of the nodes, systems, and applications while trust-based on reputation uses the TIs values to compare them with the TIs associated with peer users that have a similar role and use the same type of platform; comparing the TIs associated with user X with the TIs associated with a group of users Y that has a similar role to user X and they are using the same platform (e.g. MAC computer).

In example, if M numbers of computation tasks are allocated to a fog/edge node and there are N numbers of verifications results that can prove a computing node's misbehavior, then reputation, R, of this computing node can be expressed as a ratio of R=N/M. The lower the value of R, the higher is the reputation. This reputation number can be used to punish or reward a node by the stakeholders (e.g., participating fog/edge computing nodes) as a candidate for verification and/or even bid winner.

The deposit that a node stakes out during the bidding can be used. The smart contract can be used to assess the reputation of individual fog/edge computing nodes. Due to the transparency of BC network, the amount of staked deposits, T, and the balance, S, of the past period of time can be obtained. The ratio N/M can be used to indicate reputation as well. Here, the larger value of the ration is the higher reputation. In one embodiment, these two reputation metrics can be combined have a resultant metric providing different weights as appropriate for selection of miners and/or bid winners.

The general working principles of the hybrid computing BC network contract can be the same like those of described for the fog/edge computing BC network: (a) Incentivizing the miners, (b) Collaborative computation tasks, and (c) Punishing the misbehaving computing nodes. Smart contract-enabled distributed collaborative trusted hybrid computing services negotiation can be the same as those of described for the fog/edge computing BC network. Distributed verification and incentives/rewards for hybrid computing can be the same as those of described for the fog/edge computing BC network. Distributed trust reputation system for hybrid computing can be the same as those of described for the fog/edge computing BC network.

The general working principles of each of the cloud computing BC networks are the same like those of described for the fog/edge computing BC network: (a) Incentivizing the miners, (b) Collaborative computation tasks, and (c) Punishing the misbehaving computing nodes. The virtual cloud computing nodes of a cloud computing network can provides the view to the outside world that the operations of a cloud is logically centralized and transparent to the BC functions. Logically centralized verification and incentives for cloud computing can be the same as those of described for the fog/edge computing BC network for each of the cloud computing BC networks. Logically centralized trust reputation system for cloud computing can be the same as those of described for the fog/edge computing BC network for each of the cloud computing BC networks.

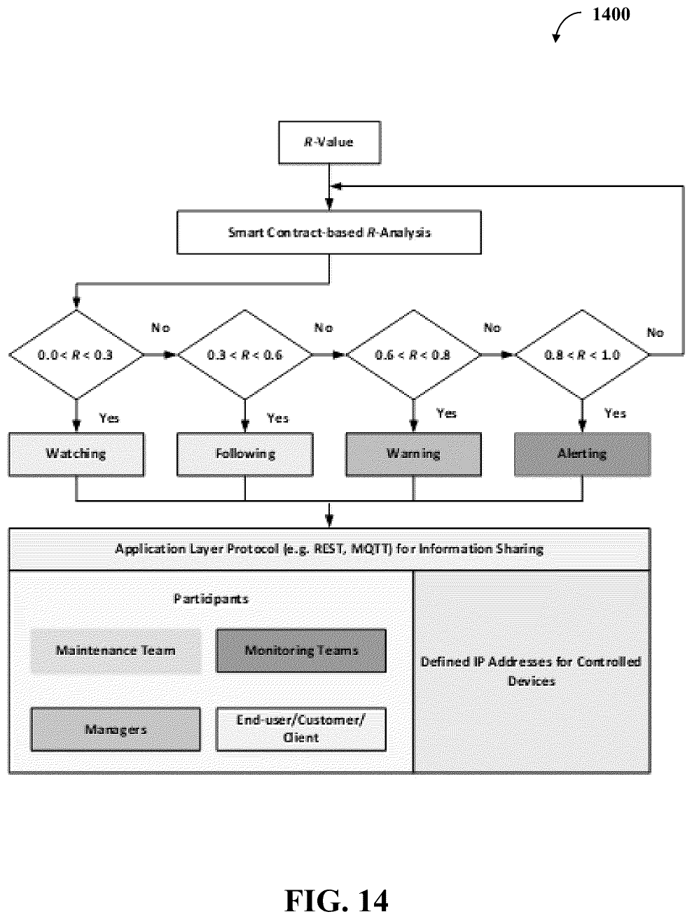

FIG. 14 illustrates one embodiment of a flow 1400 for a monitor & control smart contact; as an example, this can be for IoT/drone/sensors for transparent information sharing. This example can be employed in the monitoring of the high-value target (HVT) by the IoT/drone that is sending continuous live video stream to the cloud for analysis for a possible match with the designated target. A reconstructed image quality in identifying possible target of the received video streams can be compared with the image quality of the known HVT target using a threshold. Consider the following equation:

$$R = \frac{\begin{matrix}Quality of the Reconstructed \\ Imahe of the Possible HVT Target\end{matrix}}{Quality of the Image of the known HVT Target} \qquad ( 1 )$$

The reconstructed image quality of the sensed target can vary based on a variety of reasons such as weather, movement, surroundings, distances, and others. The accuracy in identifying the actual target is highly critical. As a result, the value of R can also change. In one example, consider R varies from a scale from 0.0 to 1.0. Table I shows the ranges of image quality matching and their corresponding implications.

TABLE 1
Image Quality Matching Ranges

| R Value Range | Image Quality Matching Condition |
|---|---|
| 0.0-0.3 | HVT Target Match: Fair -> Watching |
| 0.3-0.6 | HVT Target Match: Good -> Following |
| 0.6-0.8 | HVT Target Match: Better -> Warning |
| 0.8-1.0 | HVT Target Match -> Alarming |

That is, if the reconstructed image quality exceeds certain values of the threshold ratios R, it will have corresponding matching conditions (e.g. Fair/Watching, Good/Following, Bette/Warning, and Match/Alarming).

In this example, there can be a single cloud. Three additional functional entities can be added as follows: (a) Actuator and Alert Display of the end-user/customer premises network that displays alerts (b) Specific application function (e.g. alert generation) in the cloud and (c) A Monitoring Center located in the cloud that can be connected in the Web server that generates Alerts informing the appropriate stakeholders.

The Fog/Edge BC can be configured to not be involved in this service because it is not the Fog/Edge computing services. It is the cloud computing services that are offered by the cloud computing servers.

The following is a case for how communications can flow between IoT/Drone/Sensors and the cloud computing server: IoT/Drone/Sensors->Smart Contracts->Fog/Edge Computing BC Network->Fog/Edge Computing Node (Anchor) (broadcast)->Hybrid Computing BC Network->Virtual Cloud Computing Node (broadcast)->Smart Contracts (Negotiation)->Cloud Computing BC Network->Cloud Computing Server. The Cloud Computing Server can process the tasks of preProcessing( ), formatData( ), and R-Data( ); R-Data( ) can comprise the threshold value of R. The specific value of R that been computed by the cloud server can be used to generate a specific alert message: Fair/Watching, Good/Following, Bette/Warning, or Match/Alarming. These types of tasks can generate a specific alert message comparing the threshold values of R and can be done using smart contracts.

A first smart contract can be over the Hybrid Computing BC by the end-user/customer and a second smart contract can be used over the Cloud Computing BC Network that connects the virtual computing node and all the servers of the cloud.

The below table can describe the functions of the smart contracts used over the Hybrid Computing BC Network; the smart contracts can be a main contract with multiple sub-contracts such as cloud service that comprises the HVT Quality-of-Experience (QoE) and participant that that can control the participants for sharing the alert information from the end-user/customer side.

TABLE 1
Smart Contracts Types and Their Functions
over the Hybrid Computing BC Network

| Smart Contracts | Functions |
|---|---|
| Cloud Service | HVT Quality-of-Experience (QoE) |
| Participant | Add Participant |
| | Delete Participant |
| | Search Participant |
| | Verify Participants |
| | Autonomous IP Transmission |

The QoE that can be translated into R-values using the Smart Contracts (e.g., through HVT QoE sub-contract) can be critical to the end-user/customer. Based on this information, the end-user/customer can take a critical decision such as “Attack the HVT Target.”

The smart contract (e.g., from the sub-contract: Participant) can be used to control the access of the participations for sharing the alter information from the end-user/customer side. This network can accept the operation from the added participants (e.g., only from the added participants). A participant can have the authority to either accept or reject the requests and can trace changes in the CD network. Participants can be equipped with IDs and secret signature keys to join this network and to inquire about the data history. The algorithm can be generated for registering a participant is based on the number of remaining unregistered participants, number of modifications, and the hash values of modifications, while the outputs can be the participant's public key (PPK), private key (PPVK), and addresses achieved from secret signature keys and public keys. The Smart Contracts can execute the control of the participants proactively using the algorithm.

Table 3 depicts the Smart Contracts types and their functions over the Cloud Computing BC Network. There can be multiple sub-contracts, and in Table 3 the sub-contracts can be Participant (e.g., that control the access of the participants from the cloud service provider side) and Monitor & Control (e.g., that performs the critical functions: HVT Monitor, Analyze, Generate Alert, and Invoke Messaging Service).

TABLE 3
Smart Contracts Types and Their Functions
over the Cloud Computing BC Network

| Smart Contracts | Functions |
|---|---|
| Participant | Add Participant |
| | Delete Participant |
| | Search Participant |
| | Verify Participants |
| Monitoring & | HVT Monitor |
| Control | Analyze |
| | Generate Alert |
| | Auto-Enabling of Alert messages (e.g. |
| | Fair/Watching, Good/Following, Bette/Warning, and |
| | Match/Alarming) using Application Layer Protocol |
| | over IP Network |

The Participant sub-contract can be similar to what occurs for a Hybrid Computing BC network. This can control the access of the participants from the cloud computing service provider side.

The Monitor & Control sub-contract can be used for proactive execution of the four critical functions related to alerts. The HVT tracking data can be in the cloud changes with regard to its R values. The changes in values of R can be compared with pre-defined threshold limit values as shown in Table 3 in smart contracts. A function HVT_Monitor( ) can be called to compare the value of R with the R stored threshold value in the smart contract.

The function can call an object Analyze ( ). The associated sub-contracts and functions can serve as a directory instead of reporting back to the main smart contract and control the attached actuators to alert the managers and monitoring teams. Moreover, the sub-contracts can write the transactions in the core BC network as a permanent record. In one embodiment, the main and sub-contracts can be written and deployed separately in a BC network, calling by using their addresses.

The flow 1400 illustrates how the smart contracts-based analysis that can be used over the Cloud Computing BC Network can be employed for appropriate alerts message generation (e.g. Watching, Following, Warning, or Alarming) knowing the threshold values of R for the image qualities of the high-value target (HVT) information. At the same time, the smart contracts can proactively invoke the application protocol for send the Alerts messages over the IP network (e.g. calling of the specific application function entity that generates the alerts messages for sending to the appropriate stakeholders).

The IoT/Drone can send a live video stream of the HVT target in the cloud in accordance the service contract of the end-user/customer (e.g., IoT/Drone/Sensor). The smart contacts of the end-user/customer can be associated with the Hybrid Computing BC at time of service provisioning. The Virtual Cloud Computing Node that is also the member of the Cloud computing BC server computing network can send the transactions/blocks to the to the appropriate cloud computing sever. Note that there could be another smart contract used between the users of the cloud computing BC network where the virtual cloud computing node and the cloud computing server are connected. This smart contract that is used over the cloud computing BC network be configured to not be visible to the end-user/customer.

FIG. 15A illustrates a high-level logic flow 1500A of smart contracts and transparent information sharing. FIG. 15B illustrates a low-level logic flow 1500B for members of the fog/edge computing blockchian network of smart contracts and transparent information sharing. FIG. 15C illustrates a low-level logic flow 1500C for members of the hybrid computing blockchian network of smart contracts and transparent information sharing. FIG. 15D illustrates a low-level logic flow 1500D for members of the cloud computing blockchian network of smart contracts and transparent information sharing.

FIG. 15 illustrates the logical flow of the blocks that retain the information of transactions related to the live video streams of HVT target that are transferred to the cloud for processing to monitor and control using smart contracts over BC Networks. The transactions retaining the information of the HVT live video stream can be formed as blocks (F1) by the IoT/Drone/Sensors (end-user/customer) and use smart contracts (e.g., consistent with what is shown in Table 2) for sending to the fog/edge computing node that acts as the anchor for services in the fog/edge and cloud computing network. Knowing the participant address, the smart contracts can proactively send to the blocks (F2) fog/edge computing node that broadcasts the blocks (F3) over the hybrid computing BC network. The fog/edge computing node can recognize from the smart contracts that this computation task can benefit from being executed in the cloud and not in at a fog/edge computing node. In one embodiment, the fog/edge computing node could use the smart contracts for auto-execution of broadcast reliving some of those works related to broadcasting.

There can be some transit BC nodes between the source and destination BC node and with this blocks (F4) can traverse over the BC network and finally the blocks (F4) can reach the birtual cloud computing node that uses the smart contracts, such as consistent with Table 3, (blocks 5->blocks 6) to facilitate auto-execution of broadcasting the blocks (F6) over the cloud computing BC network, with the virtual cloud computing node being a member of the hybrid and the cloud computing BC network.

Of many cloud servers in the cloud, with these cloud servers being members of the cloud BC network, and algorithm can be employed as to determine which server is to execute this computation task. A virtual computing node can broadcast a task specification inviting bids using smart contracts (e.g., in accordance with Table II) among cloud computing nodes. A cloud computing server can reply back describing its capabilities (e.g. amount of computing capacity, processing time, and end-to-delay). The virtual computing node can evaluate the bid responses collaboratively using the cloud computing BC network with help of miners; bidding and bid evaluation information can be stored in the BC network using irreversible hyper-ledger that can be checked by the stakeholders. The winning bid, in one embodiment, can have the lowest cost in terms of available computing power (e.g., higher available computing power means lower cost) and superior performances (e.g., lower processing time, lower end-to-end delay).

The winner cloud computing server can process the blocks (F7), for example, there can be preprocessing, formatting of data, and finally the R-Data value. At this point, the server can use the smart contracts (Table 3) that generates the alerts messages, which can be done with Blocks (F1) of transaction headers of real-time HVT video payloads of IoT/sensors (end-user/customer) being sent over the fog/edge computing BC network to the anchor node using smart contracts. Smart contracts can auto-execute the transmission of Blocks (F2) to the anchor fog/edge computing node over the fog/edge computing BC network.

The anchor fog/edge computing node, which can become the single point of contact for the end-user/customer, can decide that the computational task desires to be executed by the cloud based on services specification of smart contracts should be performed. An anchor fog/edge computing node being the member of fog/edge and hybrid computing BC network can broadcast Blocks (F3) of the hybrid computing BC network.

The hybrid computing BC network can send Blocks (F4) to the a virtual cloud computing node (e.g., selected through smart contract bidding). The anchor virtual cloud computing node that is the single point of contract for a given cloud can broadcasts a bid among cloud computing nodes over the cloud computing BC network. Once the winning cloud computing node is selected, the anchor virtual cloud computing node can send Blocks (F5) to smart contracts for auto-execution of broadcast over the cloud computing BC network for sending the winner.

The cloud computing BC network can send Blocks (F7) to the winning cloud computing node/server. The winning cloud computing node can perform the following processing functions of the received blocks (F7): preProcess( ) (F8), formatData( ) (F9), and R-Data( ) (F10); then takes the help of smart contracts through sending R-Data( ) (F11).

Smart Contracts can use an algorithm to find what kind of Alert message (e.g. Watching, Following, Warning, or Alarming) should be generated based on R-Data( ) (F11) received from the winning cloud computing node/server. Once the processing is complete in determining a specific Alert message, smart contracts can set up a call( ) (F12) to the specific application function server for generation of that specific Alert message.

The specific application function server sends the Alert message SendAlert (F11) to the anchor virtual cloud computing node. Write (F12) can be saved in the cloud computing BC network as an immutable permanent record.

The anchor virtual cloud computing node can perform the following functions: (a) send the Alert message Alert Information Sharing (F13) to the anchor fog/edge computing node for sharing with the end-user/customer as appropriate, (b) send the Alert message Web_JS Alert (F14) to a web-based monitor center for early warnings, and (c) store Write (F15) for the event to the Hybrid Computing BC Network. The anchor fog/edge computing node can sends the alert message Alert Information Sharing (F15) to the actuator and alert display system of the end-user/customer.

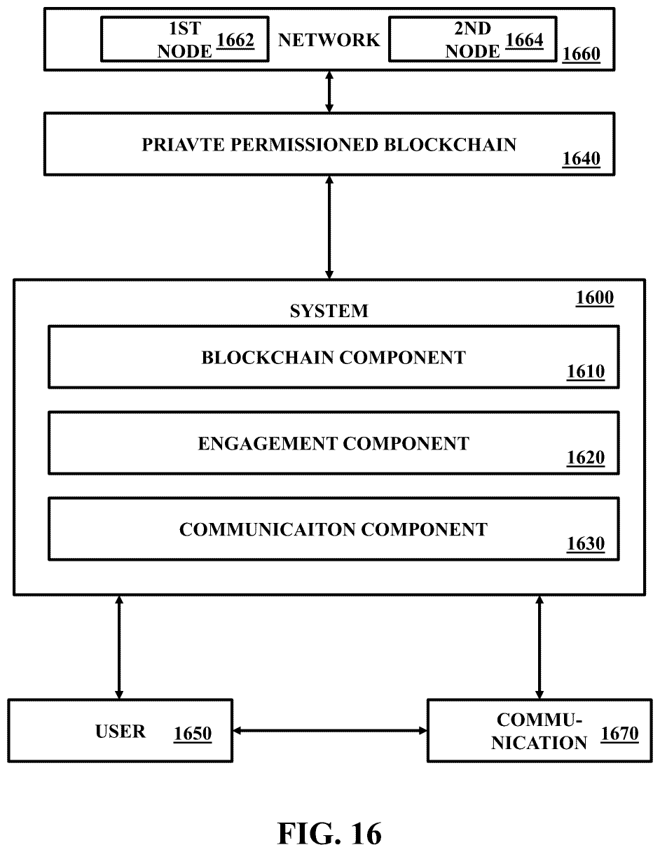

FIG. 16 illustrates one embodiment of a system 1600 comprising a blockchain component 1610, an engagement component 1620, and a communication component 1630. The blockchain component 1610 can be configured to manage a private permissioned blockchain 1640 (e.g., a private permissioned blockchain network); examples can include management of a backbone-based private permissioned blockchain, an access network private permissioned blockchain, or a hybrid network with management of backbone-based private permissioned blockchain and an access network private permissioned blockchain. In one embodiment, the access network private permissioned blockchain and the backbone-based private permissioned blockchain overlap. In one embodiment, where the access network private permissioned blockchain and the backbone-based private permissioned blockchain are separate and distinct, the backbone network and access network are logically independent, and the backbone network and access network are physically separate.

The engagement component 1620 can be configured to engage a user 1650 with a network 1660 (e.g., an access network or backbone network) by way of the private permissioned blockchain 1640, with the network comprising a first node 1662 and a second node 1664. The communication component 1630 can be configured to enable a communication 1670 with the user 1650 and the first node 1662 by way of the private permissioned blockchain 1640; communication with the first node 1662 can be part of communication with the network 1660. The private permissioned blockchain 1640 can be, at least in part, a fog/edge computing center private permissioned blockchain that pertains to a computing center set of the network 1660 and/or a cloud-based private permissioned blockchain that pertains to a cloud set of the network 1660. In one embodiment, the first node 1662 and/or the second node 1664 can be cloud nodes, fog/edge computer center nodes, or a combination thereof (e.g., the first node 1662 being a cloud node and the second ndoe 1664 being a fog/edge node).

While the private permissioned blockchain 1640, the user 1650, and the network 1660 are illustrates as separate, in one embodiment they can be integrated. In one example, the private permissioned blockchain 1640 and the user 1650 can be part of the network 1660, such as the user 1650 being the second node 1664. The user can engage with the network 1660 by way of the second node 1664. The second node 1664 can function as a point of contact of the user 1650 to the network 1660 for security and computing. The second node 1664 can be the single node (not two or more) the user 1650 engages with the network 1660, such as when the network 1660 is the access network.

The private permissioned blockchain 1640 employs a consensus algorithm and the communication 1670 can be between the user 1650 and the first node 1662 as a payload. A header information set about a transaction set for the payload can be sent over the private permissioned blockchain 1640 and the payload can be sent between the user 1650 and the first node 1662 outside the private permissioned blockchain 1640 after the header information set is verified.

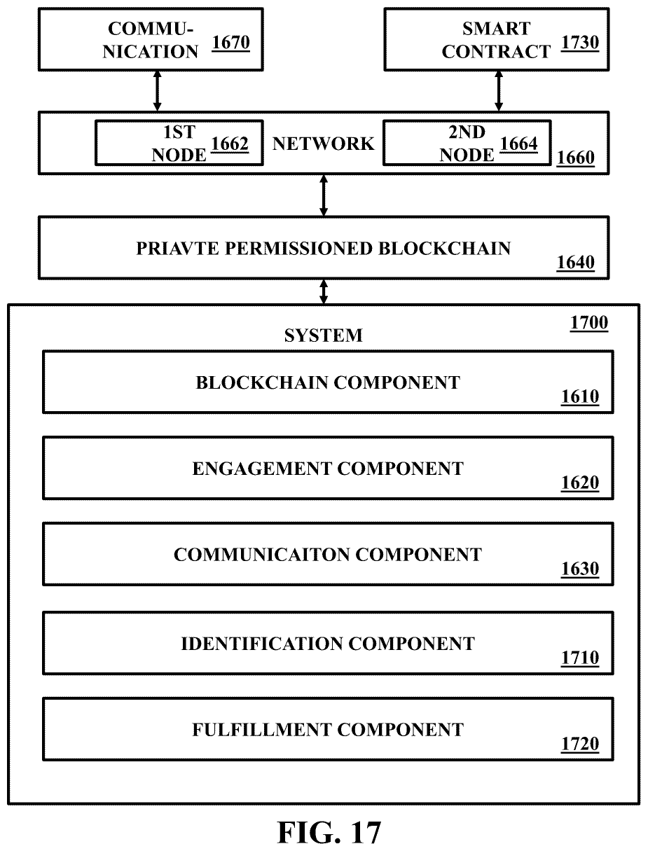

FIG. 17 illustrates one embodiment of a system 1700 comprising the blockchain component 1610, the engagement component 1620, the communication component 1630, an identification component 1710, and a fulfillment component 1720. The identification component 1710 can be configured to identify that the first node 1662 receives the communication 1670 (e.g., the communication being a call). The fulfillment component 1720 can be configured to cause the first node 1662 to control fulfillment of the call by way of a smart contract 1730. In one embodiment, the first node 1662 can have sole node responsibility for control of the fulfillment of the call (e.g., the second node 1662 does not have control for fulfillment of the call).

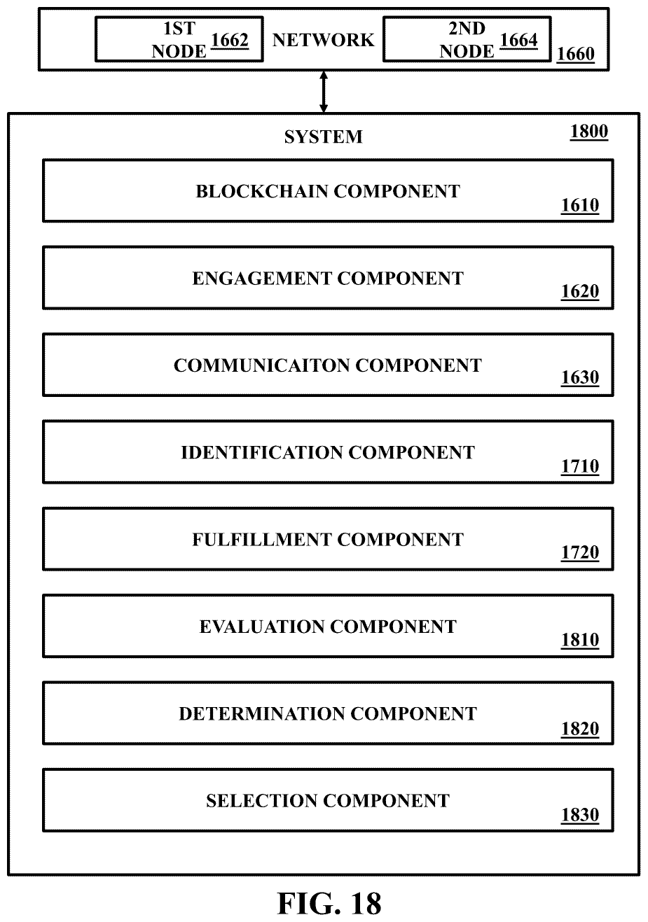

FIG. 18 illustrates one embodiment of a system 1800 comprising the blockchain component 1610, the engagement component 1620, the communication component 1630, the identification component 1710, the fulfillment component 1720, an evaluation component 1810, a determination component 1820, and a selection component 1830. The evaluation component 1810 can be configured to perform an evaluation of the first node 1662 and the second node 1664 with regard to chain length to produce an evaluation result. The determination component 1820 can be configured to determine a longer chained node among the first node 1662 and the second node 1664 through employment of the evaluation result. The selection component 1830 can be configured to select the longer chain node for fulfillment of the call.

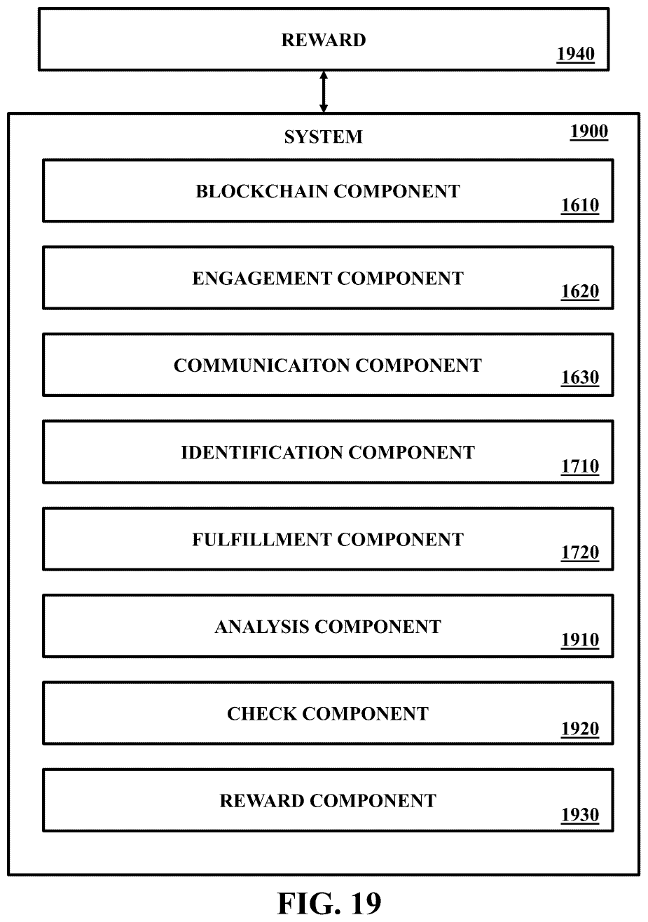

FIG. 19 illustrates one embodiment of a system 1900 comprising the blockchain component 1610, the engagement component 1620, the communication component 1630, the identification component 1710, the fulfillment component 1720, an analysis component 1910, a check component 1920, and a reward component 1930. The analysis component 1910 can be configured to perform an analysis on how successful the call is fulfilled to produce an analysis result. The check component 1920 can be configured to determine if the call was fulfilled successfully enough to earn a reward based, at least in part, on the analysis result. The reward component 1930 can be configured to award the reward when the call was fulfilled successfully enough.

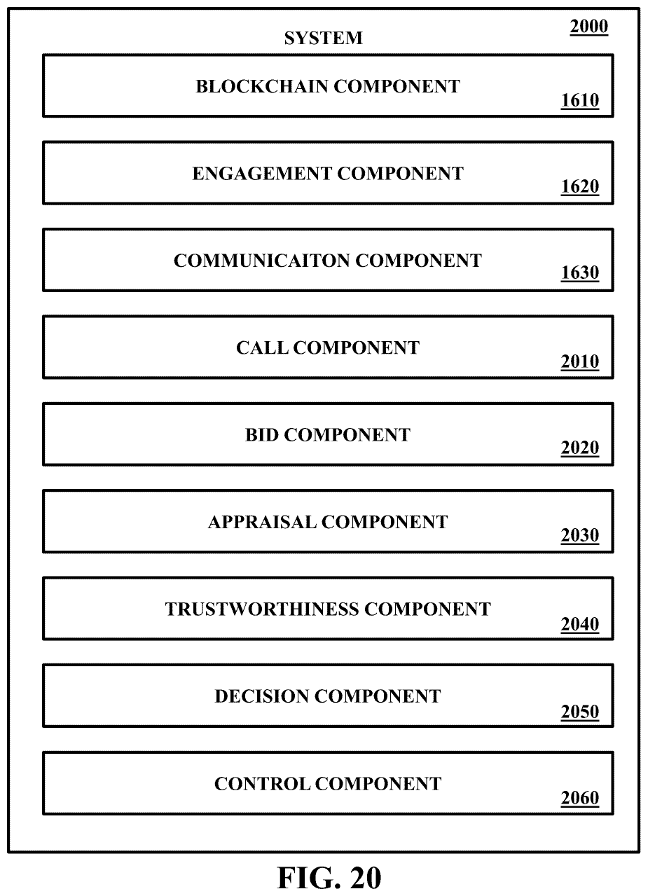

FIG. 20 illustrates one embodiment of a system 2000 comprising the blockchain component 1610, the engagement component 1620, the communication component 1630, a call component 2010, a bid component 2020, an appraisal component 2030, a trustworthiness component 2040, a decision component 2050, and a control component 2060. The call component 2010 can be configured to identify the communication 1670 of FIG. 16 (e.g., the communication being a call). The bid component 2020 can be configured to receive a first bid for the call from the first node 1662 of FIG. 16 and a second bid for the call from the second node 1664 of FIG. 16. The appraisal component 2030 can be configured to appraise the first bid and the second bid to produce an appraisal result. The trustworthiness component 2040 can be configured to determine a trustworthiness of the first node 1662 of FIG. 16 and a trustworthiness of the second node 1664 of FIG. 16 to produce a trustworthiness result. The decision component 2050 can be configured to make a decision to use the first bid over the second bid based, at least in part, on the appraisal result and the trustworthy result. The control component 2060 can be configured to cause the first node 1662 of FIG. 16 to control fulfillment of the call by way of the smart contract 1730 of FIG. 17 in response to decision.

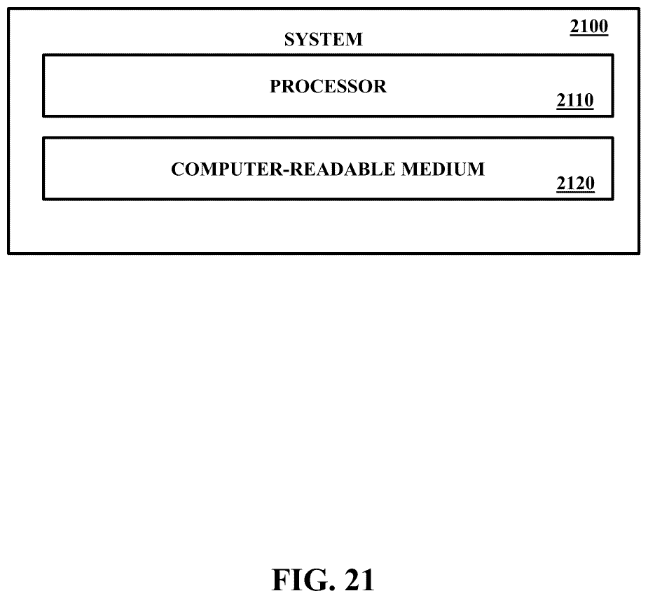

FIG. 21 illustrates one embodiment of a system 2100 comprising the processor 2110 and the computer-readable medium 2120 (e.g., non-transitory computer-readable medium). In one embodiment, the computer-readable medium 2120 is communicatively coupled to the processor 2110 and stores a command set executable by the processor 2210 to facilitate operation of at least one component disclosed herein, such as the engagement component 1620 of FIG. 16. In one embodiment, at least one component disclosed herein, such as the communication component 1630, can be implemented, at least in part, by way of non-software, such as implemented as hardware by way of the system 2100. In one embodiment, the computer-readable medium 2120 is configured to store processor-executable instructions that when executed by the processor 2110, cause the processor 2110 to perform at least part of a method disclosed herein (e.g., at least part of one of the methods 2200-2500 discussed below).

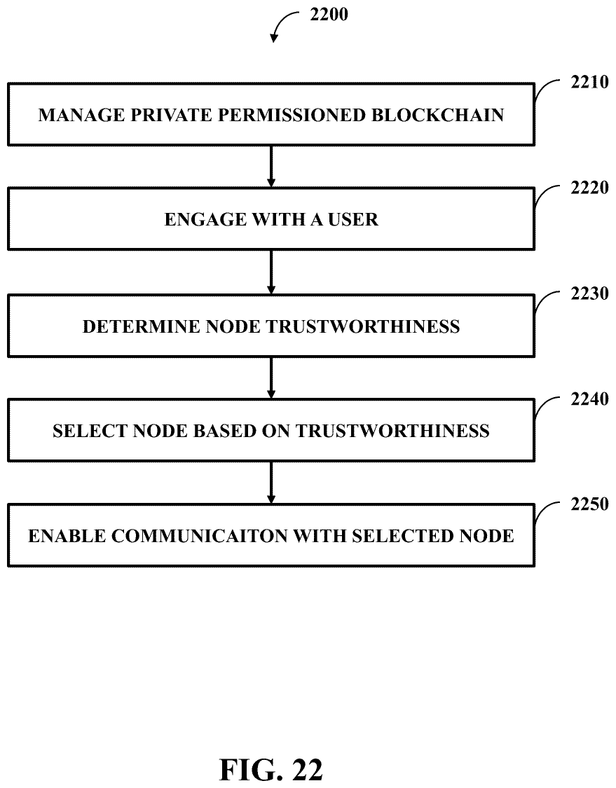

FIG. 22 illustrates one embodiment of a method 2200 comprising five actions 2210-2250. At 2210, the private permissioned blockchain can be managed. At 2220, a user can engage with a network by way of the private permissioned blockchain, the network comprising a first node and a second node. At 2230, a determination can be made as to a trustworthiness of the first node and a trustworthiness of the second node. At 2240, selection of the first node for transfer of the communication can occur by virtue of the trustworthiness of the first node being higher than the trustworthiness of the second node. At 2250, communication with the user and the first node can be enabled by way of the private permissioned blockchain.

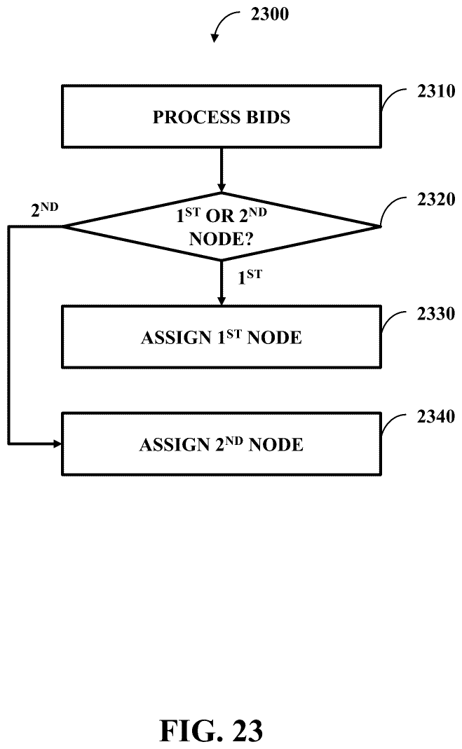

FIG. 23 illustrates one embodiment of a method 2300 comprising four actions 2310-2340. At 2310, a call can be identified and a bid set can be received, such as a first bid for the call from the first node and a second bid for the call from the second node. The first bid and the second bid can be appraised to produce an appraisal result. At 2320, a decision can be made on a bid to use based, at least in part, on the appraisal result, such as to use the first bid over the second bid. Action 2330 can function as to cause the first node to control fulfillment of the call by way of a smart contract in response to decision and action 2340 can function as to cause the second node to control fulfillment of the call by way of a smart contract in response to decision.

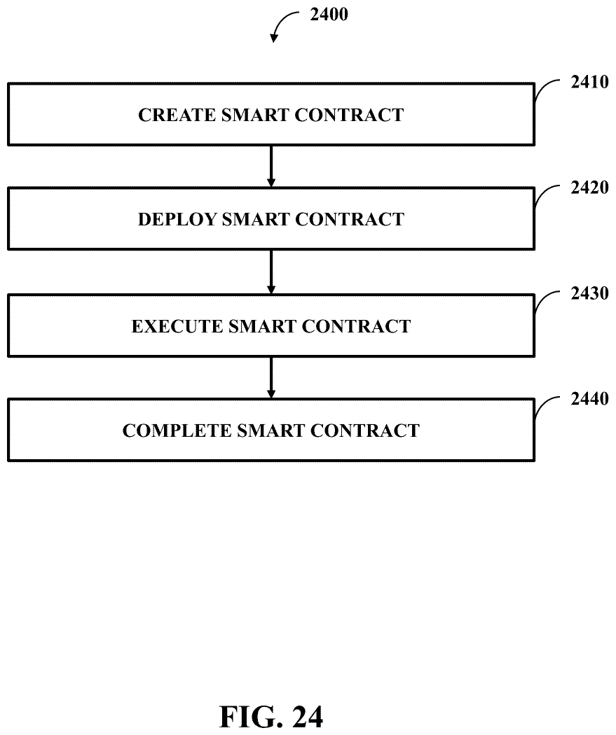

FIG. 24 illustrates one embodiment of a method 2400 comprising four actions 2410-2440. At 2410, there can be creation of a smart contract through negotiation between parties resulting in design, implementation, and validation of the smart contract. At 2420, there can be deployment of the smart contract that can include storing the contract on the blockchain and digital asset freezing of involved parties. At 2430, there can be execution of the smart contract that can include contract evaluation and auto-execution of the contract once triggered. At 2440, there can be completion of the smart contract that can include updating a state, allocating assets, and unfreezing assets.

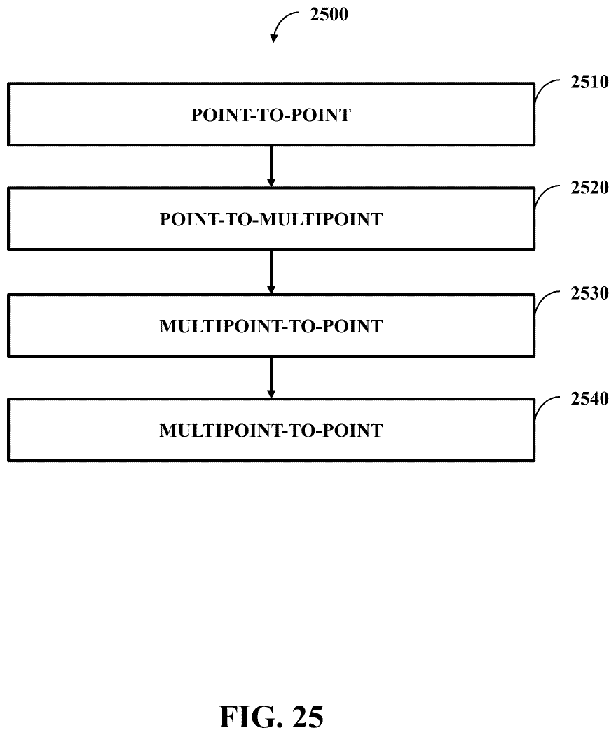

FIG. 25 illustrates one embodiment of a method 2500 comprising four actions 2510-2540. From a flow of communications point of view, the method 2500 can implement Point-to-Point 2510, Point-to-Multipoint 2520, Multipoint-to-Point 2530, or Multipoint-to-Multipoint 2540 A given point can contain the functional entity like end-user device (e.g. smart phone, laptop, and terminal), internet-of-things, network device (e.g. server, router), application software, hardware, and others.

What is claimed is:

1. A system, comprising:
a blockchain component configured to manage a private permissioned blockchain;
an engagement component configured to engage a user with a network by way of the private permissioned blockchain, the network comprising a first node and a second node; and
a communication component configured to enable a communication with the user and the first node by way of the private permissioned blockchain.

2. The system of claim 1,
an identification component configured to identify that the first node receives the communication, the communication being a call; and
a fulfillment component configured to cause the first node to control fulfillment of the call by way of a smart contract.

3. The system of claim 2, comprising:
an evaluation component configured to perform an evaluation of the first node and the second node with regard to chain length to produce an evaluation result;
a determination component configured to determine a longer chained node among the first node and the second node through employment of the evaluation result; and
a selection component configured to select the longer chain node for fulfillment of the call.

4. The system of claim 2, comprising:
where the first node has sole node responsibility for control of the fulfillment of the call.

5. The system of claim 2, comprising:
an analysis component configured to perform an analysis on how successful the call is fulfilled to produce an analysis result; and
a check component configured to determine if the call was fulfilled successfully enough to earn a reward based, at least in part, on the analysis result; and
a reward component configured to award the reward when the call was fulfilled successfully enough.

6. The system of claim 1,
where the private permissioned blockchain is, at least in part, a fog/edge computing center private permissioned blockchain that pertains to a computing center set of the network,
where the private permissioned blockchain is, at least in part, a cloud-based private permissioned blockchain that pertains to a cloud set of the network,
where the first node is a cloud node, and
where the second node is a fog/edge computer center node.

7. The system of claim 6, comprising:
a call component configured to identify the communication, the communication being a call;
a bid component configured to receive a first bid for the call from the first node and a second bid for the call from the second node;
an appraisal component configured to appraise the first bid and the second bid to produce an appraisal result;
a trustworthiness component configured to determine a trustworthiness of the first node and a trustworthiness of the second node to produce a trustworthiness result;
a decision component configured to make a decision to use the first bid over the second bid based, at least in part, on the appraisal result and the trustworthy result; and
a control component configured to cause the first node to control fulfillment of the call by way of a smart contract in response to decision,
where the user is part of the network and
where the private permissioned blockchain is part of the network.
where the communication with the user and the first node is a payload,
where a header information set about a transaction set for the payload is sent over the private permissioned blockchain,
where the payload is sent between the user and the first node outside the private permissioned blockchain after the header information set is verified.

8. The system of claim 1,
where the private permissioned blockchain is, at least in part, a cloud-based private permissioned blockchain that pertains to a cloud set of the network,
where the first node is a first cloud node, and
where the second node is a second cloud node.

9. The system of claim 1,
where the private permissioned blockchain is, at least in part, a fog/edge computing center private permissioned blockchain that pertains to a computing center set of the network,
where the first node is a first fog/edge computer center node, and
where the second node is a second fog/edge computer center node.

10. The system of claim 1,
where the user is part of the network,
where the private permissioned blockchain is part of the network, and
where the private permissioned blockchain employs a consensus algorithm.

11. The system of claim 1,
where the communication with the user and the first node is a payload,
where a header information set about a transaction set for the payload is sent over the private permissioned blockchain,
where the payload is sent between the user and the first node outside the private permissioned blockchain after the header information set is verified.

12. The system of claim 1,
where the user engages with the network by way of the second node and
where the second node functions as a point of contact of the user for security and computing.

13. The system of claim 1,
an identification component configured to identify the communication, the communication being a call;
a bid component configured to receive a first bid for the call from the first node and a second bid for the call from the second node;
an appraisal component configured to appraise the first bid and the second bid to produce an appraisal result;
a decision component configured to make a decision to use the first bid over the second bid based, at least in part, on the appraisal result; and
a fulfillment component configured to cause the first node to control fulfillment of the call by way of a smart contract in response to decision.

14. The system of claim 1, comprising:
a trustworthiness component configured to determine a trustworthiness of the first node and a trustworthiness of the second node;
a decision component configured to select the first node, for transfer of the communication, by virtue of the trustworthiness of the first node being higher than the trustworthiness of the second node.

15. A system, comprising:
a blockchain component configured to manage an access network private permissioned blockchain;
an engagement component configured to engage a user with an access network by way of the access network private permissioned blockchain, the access network comprising at least one node; and
a communication component configured to enable communication with the user and the access network by way of the access network private permissioned blockchain.

16. The system of claim 15,
where the blockchain component is configured to manage a backbone-based private permissioned blockchain,
where the engagement component is configured to engage the user with a backbone network by way of the backbone-based private permissioned blockchain, the backbone network comprising at least one node,
where the communication component is configured to enable communication with the user and the backbone network by way of the backbone-based private permissioned blockchain

17. The system of claim 16,
where the access network private permissioned blockchain and the backbone-based private permissioned blockchain are separate and distinct,
where the backbone network and access network are logically independent, and
where the backbone network and access network are physically separate.

18. The system of claim 16,
where the access network private permissioned blockchain and the backbone-based private permissioned blockchain overlap.

19. The system of claim 15,
where the user engages with the network by way of a single node of the access network and
where the single node functions as a point of contact of the user for security and computing.

20. A system, comprising:
a blockchain component configured to manage a backbone-based private permissioned blockchain;
an engagement component configured to engage a user with a backbone network by way of the backbone-based private permissioned blockchain, the backbone network comprising at least one node; and
a communication component configured to enable communication with a user and the backbone network by way of the backbone-based private permissioned blockchain.
